(19) United States
(12) Patent Application Publication
(10) Pub. No.: US 2016/0099984 A1
(43) Pub. Date: Apr. 7, 2016

(54) METHOD AND APPARATUS FOR REMOTE, MULTI-MEDIA COLLABORATION, INCLUDING ARCHIVE AND SEARCH CAPABILITY

(71) Applicant: Across Lab, Inc., San Ramon, CA (US)

(72) Inventors: Sotirios KARAGIANNIS, Thessaloniki (GR); Charilaos THOMOS, Ioannina (GR); Georgios MAVROUDIS, Thessaloniki (GR)

(21) Appl. No.: 14/875,155

(22) Filed: Oct. 5, 2015

Related U.S. Application Data
(60) Provisional application No. 62/059,681, filed on Oct. 3, 2014.

(51) Int. Cl. H04L 29/06; H04L 12/58; H04L 29/08

(52) U.S. Cl. CPC H04L 65/403; H04L 67/146; H04L 67/147; H04L 65/60; H04L 51/046

(57) ABSTRACT

Embodiments of a method and apparatus for remote collaboration include a central cloud computing infrastructure configurable to capture data related to online, remote collaborative session between users via any type of Internet capable user device. Data capture includes capture of data via services/systems external to the infrastructure, and services/systems internal to the infrastructure. Methods further comprise archiving session data including video and audio from a session and any data attachments users might add to the session (during or after the session). The session data can be searched by permitted users to find any data from a session, different session a participant attended. Permitted users can add data to a session, either during or after the session occurred. Added data includes book marks that mark a point in time of a session and can be associated with comments, data attachments, and more. A rich user interface graphically displays bookmarks, comments and data over the time of the session.

### REFERENCE TO RELATED APPLICATIONS

This application claims priority from U.S. Provisional Patent Application No. 62/059,681, filed Oct. 3, 2014, which is incorporated by reference in its entirety herein.

### BACKGROUND

People today increasingly rely on the ability to communicate and collaborate with each other remotely, including sharing various forms of electronic media. Communication technologies such as PSTN, mobile phone technologies in conjunction with the Internet (VoIP) and a host of software applications have enabled this communication and collaboration. For example, applications such as GoToMeeting, Skype, Google Hangout and Webex enable users to see each other, hear each other, and share media with each other. Enterprises also rely on the ability of geographically distributed employees to work with each other and share knowledge remotely. It is desirable for enterprises to build a sharable and searchable corporate knowledge base to which anyone given access can turn for answers to questions or information about a given topic. Current communication and collaboration solutions do not have the capability to automatically archive transactions between people and/or groups. Current solutions do not have the capability to build a defined archive of multi-media knowledge that can easily be accessed by an authorized person wishing to find or make use of existing corporate knowledge. Therefore, an amazing amount of corporate knowledge is lost even as it is being developed. In order to create such a corporate knowledge base given existing technology, one or more persons are still required to act as archivist(s) to label and store electronic records of transactions and related media.

### BRIEF DESCRIPTION OF THE DRAWINGS

FIG. 1 is a block diagram of a system that facilitates both participation in a meeting and collection of contextual information from the users.

FIG. 2 is a block diagram illustrating how a system brings two types of communication together in a session for a unified experience, according to an embodiment.

FIG. 3 is an example of a user interface (UL) screen that shows how an organizer can add participants and provide the participants with information for them to accept or deny a session, according to an embodiment.

FIG. 4 is a block diagram of a system architecture according to an embodiment.

FIG. 5 is a block diagram of a system architecture illustrating a central infrastructure that facilitates the sharing of data and screen sharing from many sources, and recording of sharing sessions, according to an embodiment.

FIG. 6 is an example UI screen that illustrates the result of a search for a past session, according to an embodiment.

FIG. 7 is an example of a UI screen in which a user plays back or curates a session and views session details, according to an embodiment.

FIG. 8 is an example UI screen showing a “Main Stage” region of a Playback interface, according to an embodiment.

FIG. 9 is a diagram of a screen sharing apparatus and method, according to an embodiment.

FIG. 10 is a diagram of an apparatus and method for a web viewer screen sharing connection process, according to an embodiment.

FIG. 11 is a diagram of an apparatus and method for a recording process between two participants, according to an embodiment.

FIG. 12 is a diagram of an apparatus and method for a screen sharing process for “Solo” sessions, according to an embodiment.

FIG. 13 is a diagram illustrating UIs as they appear on user devices, according to an embodiment.

FIG. 14 is a diagram of a UI that demonstrates contextualization, according to an embodiment.

FIG. 15 is a diagram of a system overview according to an embodiment.

FIG. 16 is a representation of the user connections, networking and methods of collaboration in the Acrossio Professional Network, according to an embodiment.

FIG. 17 is a representation of the user connections and collaboration methods in a Company Network, according to an embodiment.

### DETAILED DESCRIPTION

Embodiments of the invention described herein extend multiple methods of video conferencing, and enable the creation of a knowledge archive that is easily accessed to find specific information at a later time. Embodiments of the system provide controlled access to participants for participating in and capturing collaborative sessions. During the sessions or afterwards, participants can enter information such as notes, tags and marks in various electronic formats to contextualize or comment on relevant participant information and captured environment interactions. For example, a participant can type notes, or mark sections of a video record of a conference. The marked section of the video conference can later be accessed (along with any other material related to it by the participant) by searching (e.g. key word searching) the archive.

In part, the invention is embodied in computer-executable software that integrates numerous methods of video conferencing. The methods are both vendor and technology neutral. In this description, a variety of technologies are referenced. All of these technologies can be combined as described further below into a variety of methods and devices that are useful in synchronizing or combining disparate data streams that include video, audio, text, device specific data, location, etc., into contextually rich content that can be indexed, searched, discovered, and replayed at a later time.

In embodiments, the combination of security, vendor and technology neutral data streams, internal and external content, device specific contextual data, etc., is performed according to methods and apparatus referred to herein as Vortex. As further described below, Vortex gives users the ability to participate in a video and/or audio conference while capturing the conference using differing technologies, vendor equipment and other disparate services. At the same time, the captured conference data is stored (archived) in a manner such that it is easily accessed and searched by permitted individuals at a later time. The criteria and process of granting individuals access to particular archived data is another aspect of the claimed invention.

Embodiments of the invention allow users of the system, in real time, to find and connect with subject matter experts (e.g., in the same enterprise, but not necessarily). Users can negotiate and synchronously connect to subject matter experts, capturing and contextualizing a plurality of events that occur while in a collaborative knowledge transfer session with the aim of producing relevant information and then curating, categorizing, displaying and finally sharing this knowledge in the form of relevant digital content to individuals or groups within a network of people. These same methods and systems may also be used to capture, contextualize and curate individual self-recorded events, meetings at a physical location and/or prerecorded events.

Embodiments allow for intelligently combining semantic taxonomic data with the aim to improve collective institutional knowledge for enterprises, professional networks of people and/or individuals. This may be accomplished during a live session or after the session by session participants, observers and/or other authorized users of the system.

Examples of knowledge transfer events may be a simple discussion, a collaborative session between colleagues, a business or sales meeting, a subject matter expert interview or other events where two or more parties are exchanging ideas or having a meaningful conversation, a speech, or anything that one can view or listen to in one's general surroundings. Knowledge transfer can also occur via sharing a person's recorded lecture or presentation.

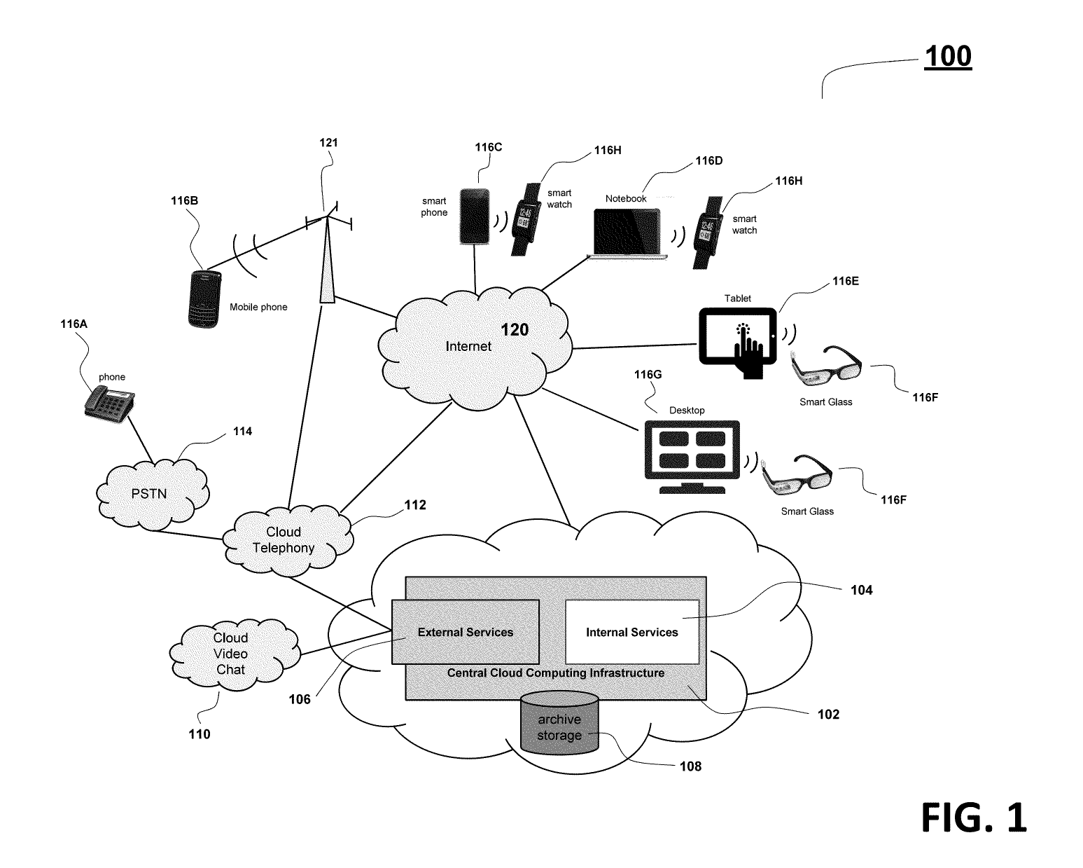

FIG. 1 is a diagram of an embodiment of a system 100 for remote multi-media collaboration, according to an embodiment. System 100 includes a central cloud computing infrastructure 102 that encompasses the inventions described and claimed herein.

Although the concepts illustrated herein may refer to a cloud computing as a single entity, there may be various servers involved. For example, the cloud infrastructure may include one server accessed by a device which may in turn access another server like a database server or a rendezvous (relay) or a media or a screen sharing server. A plurality of servers may be used in another embodiment in order to provide the services disclosed herein. The cloud computing infrastructure may execute various application programs. These may be executed in a shared or distributed manner across one or more servers with a client application executing in the computing devices.

The infrastructure 102 includes internal services 104 and external services 106.

Internal services (or internal cloud services or system services) 104 are the services provided by the system itself to its components or to other services and/or systems and/or third parties via an API (Application Programming Interface) or other means of integration. They are provided so the later can utilize Acrossio's (as used herein, “Acrossio” is another term for the claimed system and method as implemented, for example by the central cloud computing architecture) internal resources, functions, storage, etc. Such services can be but are not limited to text chat, messaging, screen sharing, file upload, digital document co-signing, co-browsing, content synchronization etc. and are generally depicted as “internal” implies Acrossio originated services via API.

External services 104 are services provided by third parties via an API, or other means of integration to the system. Such services can include cloud telephony services such as Twilio, Skype, Plivo, Tropo etc.; cloud video chat services such as OpenTok, Skype, Vidyo, Google Hangouts, Microsoft Skype for Business, Cisco Webex, Sightcall, Zoom etc.; cloud screen sharing services such as ScreenLeap, WebRTC Screen Sharing, Acrossio Screen sharing etc.; other current and future external third party services such as Email. File Sharing, Note-Sharing, co-browsing, Real Time Chat, Media & Content Services, etc. with their respective vendors/products like Microsoft Office365, Google GMail, Linkedin, Dropbox, Google Drive, Box Cloud file sharing, Evernote, Slack cloud messaging, YouTube, Vimeo, Twitter, Facebook etc. The infrastructure 102 further includes archive storage 108, which can be in one or more locations distributed anywhere that is accessible via known networks.

Many participants in a collaborative session may be in many locations. A collaborative session occurs over the Internet 120 using cloud telephony 112 and/or cell phone network infrastructure 121, cloud video chat 110, and/or PSTN 114 as examples of physical facilitators of the collaborative session. Users access the system and enter a session using one of many devices 116, including but not limited to a land-line phone 116A, a mobile phone 116B, a smart phone 116C, smart watches 116H, a desktop computer 116G, a notebook computer 116D, a tablet computer 116E, and smart glasses 116F.

Not shown, but also able to participate in collaborative sessions are one or more publicly shared devices capable of providing contextual data, such as meeting room microphones, security cameras, temperature sensors etc. via a communication subsystem (Bluetooth, near field communication-NFC technology, wireless, wired etc.) As used herein, contextual data includes any type or form of data that relates to a collaborative session, including audio data, video data, electronically captured text, Internet links to other data (in any form), etc.

The communication instances may involve various types of devices, such as normal phones, smartphones, laptops, notebooks, desktop computers, tablets, VoIP enabled devices, etc. Typically, a user may use a computing device that incorporates a display to allow for user interaction, present UI elements and contextual information.

This device might be the same one used to conduct all communication with the cloud computing infrastructure. However, the users may still use separate devices, such as a tablet (or a notebook) and a voice telephone, where contextual information is displayed and/or entered on the tablet (or the notebook) and the voice communication occurs using the voice telephone. Thus, there is no requirement that the communication device and computing device are the same.

Although the concepts are illustrated using a tablet (or a notebook), the concepts disclosed herein may be applied to a variety of other types of devices and should not be construed as being limited to only such devices.

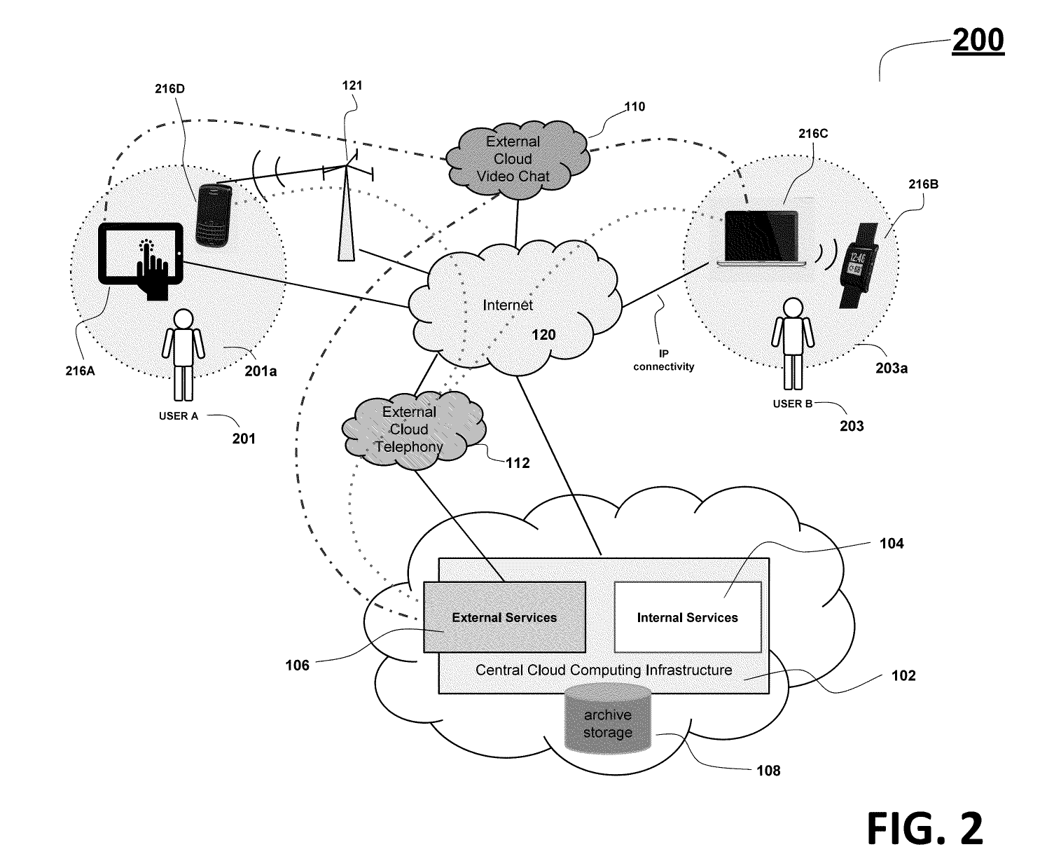

With reference to FIG. 2, an example diagram 200 illustrates users logging in to use the system as described. A user 201 and a user 203 wish to log in to the system to establish a collaborative session. Various devices 216 are available to each of the users. These devices may not be connected to each other or they may be connected to form a “Personal Area Network” like 201a or 203a. The users first notify the system about their availability by logging in to the system and their respective network (where network is a virtual network of people able to communicate with each other via the application, such as professional, personal or company networks) via a number of appropriate means depending on their location and device (i.e. mobile, home, office, phone only via SMS, etc.) and define their status (such as available and willing to have a session, busy, unavailable, etc.). This allows them to be discovered online by the system and participate in collaborative sessions or meetings from their desktop or mobile devices, phones or other devices. Each logged-in user (who is a potential meeting participant) is being connected to the centralized cloud computing infrastructure 102 of her company or personal network by means of a persistent connection channel (Channel A, not shown), the best available at the time and the device(s) they are using (TCP/IP sockets. SSL, websockets, persistent http connections, etc.). The system associates the user's device(s) with a unique identifier and stores these identifiers in a centrally accessible table in the Central Cloud Computing Infrastructure 102. Through this connection the user's device broadcasts an initial set of information including presence, connectivity status, time-zone and various contextual data like availability, location, intend to participate in a session etc. The system gathers all available information and combines it with what the system already knows from the user's directory information (name, title, position, working hours etc.) by the means of an online database and an in-memory lookup table (synchronized from time to time with the online database for scalability and resiliency). The system from this point onwards, maintains a real time updatable directory of users able to participate in a session and all the devices available to them (including possible satellite devices) with all the context it needs to decide who to call and via which communication channel (voice over IP, video chat, SMS, PSTN voice, cloud telephony, etc.). Several types of communications can be chosen while bringing participants in the session as shown in FIG. 2. Each type may occur using various forms of technologies. For example, a voice call connecting the system with a participant may involve the public switched telephone network (“PSTN”) as well as wireless carriers (cellular providers). The voice call may also involve voice-over IP (“VoIP”) technology using other wireless or wired technologies.

In the case that more than one users need to participate in a new meeting (either a scheduled one or an ad hoc one) the organizer of the meeting instructs the system to ask the participants for their consent to participate and acceptance of the rules of engagement.

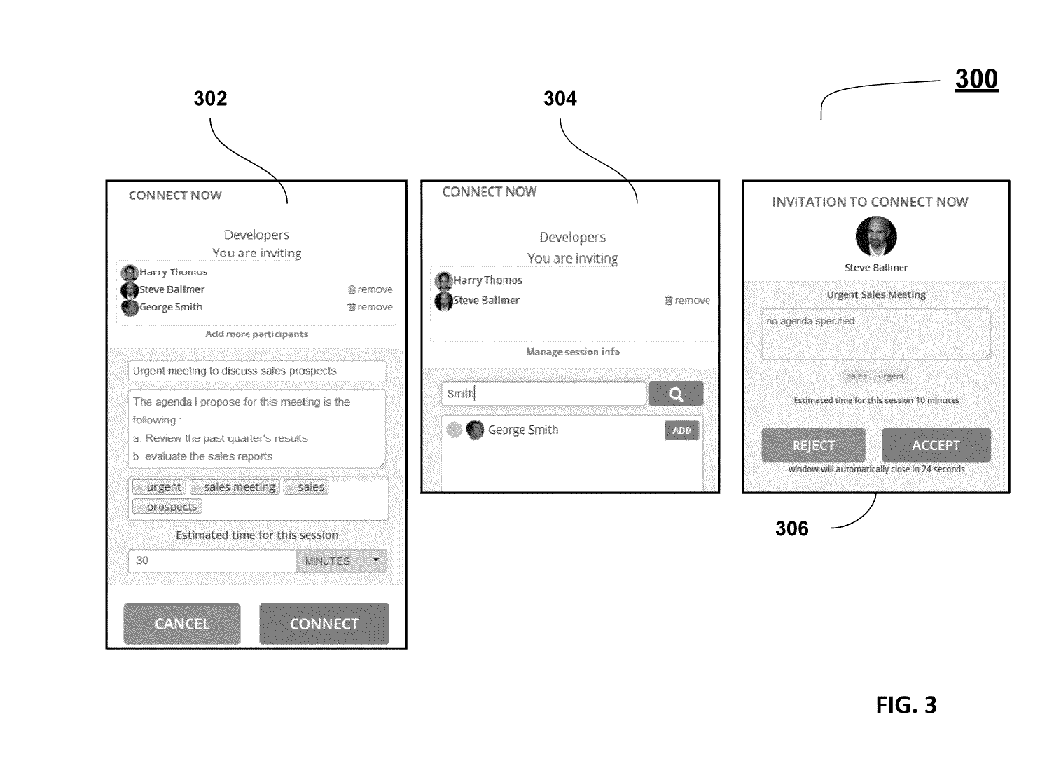

The organizer through a friendly user interface (UI), such as that of FIG. 3 at her endpoint device provides the system with sufficient information that will help the called users decide if they want to participate or deny the call. Such information might include but not be limited to the title of the meeting, the meeting agenda, the proposed time of the meeting, the scope of the meeting (if the meeting is happening in the context of a group, is private, other participants), etc.

The system attempts to find if the specific user(s) is(are) available and willing to participate in the specific session so she(they) can be brought into the Real Time session (sometimes also called Real Time Knowledge Sharing Session or RTKS). The system creates a unique session ID object and matches it with contextual information (e.g., title, agenda, estimated time, other needed participants etc.) which it provided through the organizer's UI as mentioned above. By means of a message through the channel that has been established above (Channel A) the system sends the above information to all available client device(s) (for devices that cannot state their online status—like a simple mobile phone with no internet connectivity—the system might choose to contact it through more appropriate means—like a Short Message System or SMS with a capability of texting back to accept or deny)

Each user (there could be one or multiple users in different instances) is notified by the local UI elements (audible and/or visual means) and is presented with the supplied unique Session ID's contextual information about the meeting (title, agenda, estimated time, other participants etc.). In case the user is offline, the user might get notified by SMS.

The user has a specific time span to respond to the notification (effectively accepting or rejecting the invitation for participation to the meeting). The user might choose to respond by asking for the meeting to be rescheduled in which case a mechanism for scheduling might kick in, depending also on the rules of engagement and the responses of the other users. Offline users might reply through SMS and the system will get their acceptance so it can call them in the process.

If all users that have been called reject their invitations, the session ID is marked as rejected and the session is considered ended. If any of the called users accepts the invitation and the rules of engagement do not suggest that the meeting has to be rescheduled, the session starts and users that have accepted join the meeting session.

If a user has not accepted the invitation at this point (possibly due to a timeout, ie not responding in a specific amount of time) but did not reject it either, the user stays in the session's table of participants until the organizer removes them from the table. Using this method the same user can join the session at a later stage but before the session ends.

After a user has accepted the session request, the joining process begins.

FIG. 3 is an example of a user interface (UI) screen 300 that shows how an organizer can add participants and provide the participants with information for them to accept or deny a session, according to an embodiment. Screen 302 shows the people the organizer is inviting, a short description of the meeting, a proposed agenda, and various tags that can be associated with the meeting (e.g., “urgent”, “sales meeting”, and so on). Screen 304 shows how the user is searching for people to invite by typing part or the whole of their name in a search box.

On the right 306 of the diagram an invitation for one of the invited participants appears. The invitee can accept or reflect the invitation. The invitation window automatically closes after a predetermined period of time.

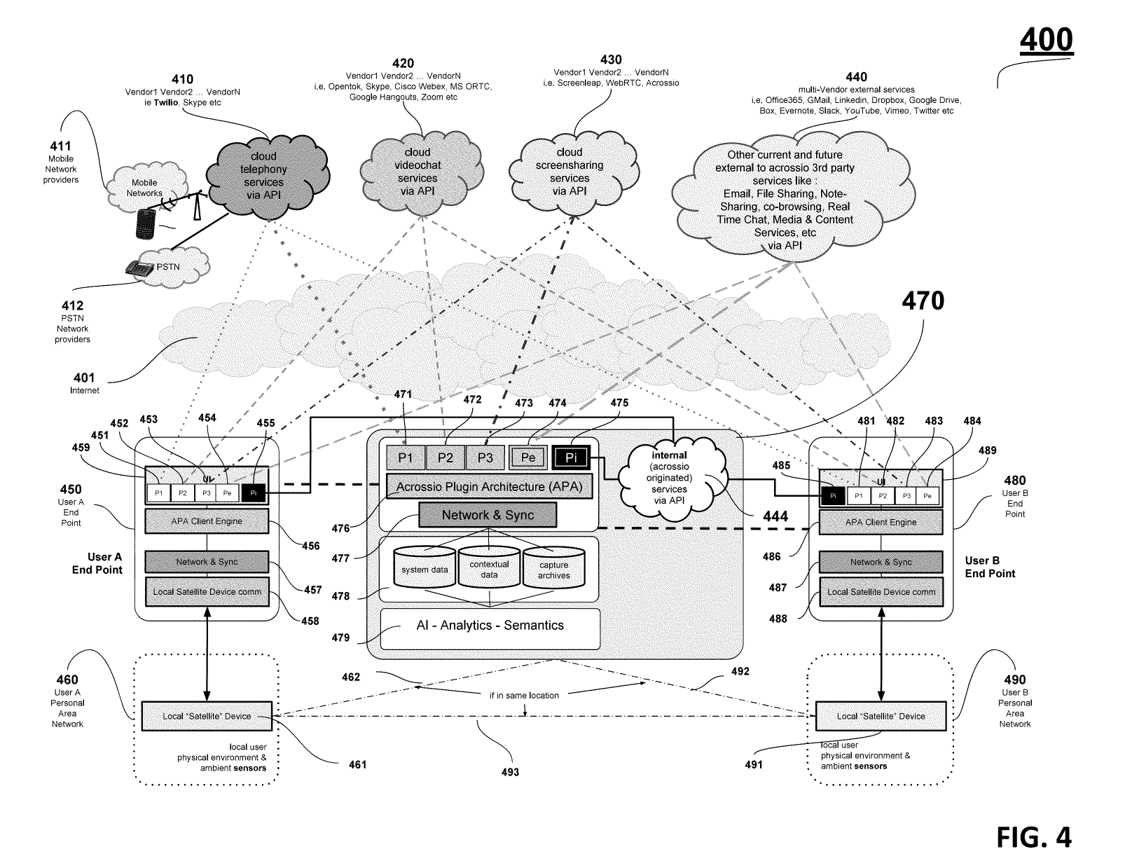

FIG. 4 is a block diagram of a system 470 architecture according to an embodiment. A system 470 is shown in a larger Internet system context 400 to illustrate the entities and system with which system 470 interacts. System 470 is responsible for capturing real time content and contextual data related to a session by utilizing a modular plugin architecture. This architecture allows the system to be agnostic to the source of the content and the contextual data (be it from external services, internal services or end client devices/satellite devices).

External services or external cloud services are services that are provided by third parties via an application programming interface (API), or other means of integration to the system so that it can utilize their resources, functions, storage, etc. Such services might be cloud telephony services via an API as depicted in element 410 that can provide connectivity to global mobile 411 or PSTN 412 networks (such as Twilio, Skype, Plivo, Tropo etc.); cloud video chat services via API 420 (such as OpenTok, Skype, Vidyo, Google Hangouts, Microsoft Skype for Business—former Lync, Cisco Webex, Sightcall, Zoom etc.); cloud screen sharing services via API 430 (such as ScreenLeap, WebRTC Screen Sharing, Acrossio external/internal Screen sharing etc.); other current and future external third party services via API 440 (such as Email, File Sharing, digital document co-signing, Note-Sharing, co-browsing, Real Time Chat, Media & Content Services, etc. with their respective vendors/products like Microsoft Office365, Google GMail, Linkedin, Dropbox, Google Drive, Box Cloud file sharing, Evernote, Slack cloud messaging, YouTube, Vimeo, Twitter, Facebook etc.).

Internal services or internal cloud services or system services are the services that are provided by the system itself to its components or other systems or later to third parties via an API or other means of integration to those services or to the system and its components so that they can utilize internal resources, functions, storage, etc. Such services can be but are not limited to text chat, messaging, screen sharing, digital document co-signing, file upload, co-browsing, etc. and are generally depicted in 444 as “internal (Acrossio originated, where Acrossio is a designation of the described and claimed system and method) services via API”.

End client device or satellite devices are devices that participate in the collaboration session and can provide the system 470 with real time context in various levels and from many networks and channels such as the internet, SMS, telephony, Bluetooth, Wi-Fi, future communication protocols etc.

The system manages, integrates, synchronizes, captures and combines multiple disparate recorded streams/inputs/information from many different sources (external and system internal services and all user assisted endpoints and satellite devices) to provide unique person-based context after a meeting (also referred to as a session) has been concluded.

In general, to use a service the system 470 generates a plurality of security keys and credentials required to initialize the necessary external cloud service for each of these cloud services used. In an embodiment, a proprietary plugin architecture called hereafter “Acrossio Plugin Architecture” or APA 476 is employed. Using a plugin engine which adheres to the Acrossio Plugin Architecture, the system dynamically loads and executes the allocated “plugin” for each external service. In this case, it enables plugin P1 471 for the external group of cloud telephony services 410; plugin P2 472 for the external group of cloud video chat services 420; plugin P3 473 for the external group of cloud screen sharing services 430; any of the plugins in the group “Pe” 474 for the equivalent cloud service in the group 440, and one of the plugins of the plugin group “Pi” 475 for any of the internal (Acrossio originated) services 444. All these plugins are service agnostic and provide abstraction in any required actions to expose the service's functionality to the endpoint client devices.

The architecture therefore allows for the system to “tap” into other systems and services that provide an interface through the means of an API or other integration communication methods and connect with their streams, effectively using them as additional “external” sources of content and contextual data. These systems might be, but are not limited to already existing conferencing equipment systems or other voice or video or other content services provided by their respective vendors.

Examples of such content carrying contextual information may include but are not limited to bookmarks, hyperlinks, permanent links (permalinks), notes, action items, mentions, media streams, clipboard data and images, shared streams and files, external media content, real time transcription etc.

For each of the above cases, the way the system integrates them is described below.

Bookmarks are collected from the users and sent to the system with personal rating referring to the time they are experiencing at a specific instance of a session. The users, through a mechanism called “bookmarking” consisting of a UI element at their endpoint device. e.g. device 450 and/or one or more of their “satellite wearable devices” such as device 460 which is enabled during the session recording phase, can place their bookmarks optionally augmented by a level of interest from zero to five (0-5), a comment, and a configurable selection of contextual data.

Short notes can be captured for the meeting, spanning from informational messages (URL links, instructions to participants, shared notes, etc.).

A special kind of note is an action oriented note, such as but not limited to tasks/to-do items, decisions etc. Actions items are delivered to all session participants via external email/sms, calendar, task management services etc., and/or internal chat/alert/messaging/etc. via services such as services 410,440,444 etc.

The system provides capture and delivery of mentions and reference oriented notes such as recommending specific content of a session via alternative communications methods such as but not limited to email, SMS, social media etc. Clipboard copies of images or pictures taken from the picture stream of the end user device(s) can be incorporated in a session. The same is true of media streams (video, audio, voice and video over IP (VOIP), telephony audio, and other future digitally encoded media streams) or shared streams/files, such as screen sharing, text chat, shared notes, co-browsing data including permalinks, and slide sharing, digital document co-signing, provided either as a system service or via the use of external cloud services.

External media content is synchronized at the time of the real time session. During a live knowledge session, users are allowed to add external media to the existing streams, either by uploading or by embedding them. This can be done through a specialized interface through which the users can select the medium to be uploaded/embedded and the specific point in time relevant to its start in which it will start playing in the stage area of the RTKS window.

When recording is on, all playback controls of the external content are also recorded, thus producing sufficient data for the system to understand which parts of the external media stream will be hidden or visible in the media and content region later on, in the playback and curation phase. Also real time and near-real time transcription data from the audio streams at the session duration can be incorporated via the use of such external or internal services. Transcription is initiated at the start of the session and ended at the end of session recording or during “X plus or minus minutes” around a bookmark and/or a period of “Y bookmark density” or other optional triggers.

Capturing may be activated/deactivated on demand, through the UI 459 or 489 of the client devices. Usually, engagement rules favor the controlling of the capturing interface only from the meeting organizer but the system might choose to allow more people to control the recording. In cases in which the only participant of the session is the organizer (self-recording sessions, or “Solo”), the capturing control is given to the organizer. When a client device requests that capturing is activated/deactivated, a real time message is sent to the system via a path such as 461-458-457-477. The system, then, transmits this message to all other client devices participating in the session in order to notify them and also to synchronize capturing status among session participants and all used services. As an example, the path to transmit to user B end point device 480 and display it in its UI would be 477-480/487-486-489.

### Data Capture Via External Services

Data capturing can be provided by some or all external services. Capturing by external services is similar to capture by internal services.

Once the system 470 receives a message to start capturing, it instructs all plugins responsible for interfacing with the external services used in the session to start capturing (e.g., plugins P1 471, P2 472, P3 473, Pe 474 and Pi 475 for the case of internal services). Each plugin carries out a specific set of instructions to the service which activates the capturing of the data provided by the external services. All communication with external services happens over the Internet 401. Once the instructions are executed, the capturing state of the external service is logged by the plugin architecture 476 and can later be used as additional contextual information.

Using the session real-time communication channel, the system propagates the plugin recording state to the client devices. The system uses the APA client engines 456, 486 of the client devices (e.g., plugins P1 451. P2 452, P3 453, Pe 454 for external services/Pi 455 for internal ones in the case of the user A endpoint 450 and plugins P1 481, P2 482, P3 483, Pe 484 for external services/Pi 485 for internal ones in the case of the user B endpoint 480) to synchronize the recording state of each external service to its respective service “driver” (a piece of software that knows how to talk both to the service and the UI), which in turn modifies the client device UI appropriately.

An example for cloud video chat would be to initialize plugins P2 472 in the system 470 which then speaks to the respective external video chat service at 420 and then notifies via the plugin-communication-plugin path 476-477-487-486 to reach P2 482 which communicates with its parent service at 420 and enables the UI 489 to display the video of the user A end point 450 at user B end point 480.

### Data Capture Via External Services

When an internal service is responsible for capturing information and data from the endpoints, the capturing process is controlled in its entirety by the system 470.

Typical cases are screen sharing recordings between the participants, local client device information and content, etc. Once the system 470 receives the message to start capturing, it instructs all plugins responsible for interfacing with system 470 (internal) services to start capturing. As above, a real time message is sent to all session client devices, containing the instructions to start capturing using the specific system (internal) service. At the endpoint, the client device APA Client Engine (e.g. 456, 486) handles this message and passes it to the appropriate drivers. Each driver initializes its recording mechanism, without starting the recording and reports its state back to the system. The system, through APA 476, synchronizes all the recording states received from all the relevant plugins of all the client devices that participate in the session. Once all system services have reported that they are initialized, a message is sent by the system to all client devices in the session. The APA Client Engine (e.g. 456, 486) of the client devices syncs the recording state of each system service to its respective service “driver”, which in turn modifies the client device UI appropriately.

### Endpoint Client Devices or Satellite Devices

In today's personal computing environments, it is common for people to carry more than one device capable of “computing”, including mobile phones or smart wearable devices (wearables). Some of these devices are low power wearable devices that are used either on their own or in conjunction with a mobile device such as a tablet or a smartphone. These devices are usually non-intrusive and can gather an increasing number of environment related contextually rich data. These devices are referred to herein as “satellite” devices. Examples of “satellite” devices are smart watches, smart glasses and other wearable devices that can record video and audio, take pictures, measure biometrics, exchange information with each other via communication protocols etc.

Once the system 470 receives a message to start capturing, it instructs all plugins responsible for interfacing with endpoint client (like 450,480) and satellite (such as 461,491) devices which usually participate in a “personal area network” (such as 460, 490) to start capturing. A real time message is sent to all session client devices, requesting them to report their attached satellites and contextual information capturing capabilities. Through its APA, client engine (e.g. 456, 486), the client device (e.g. 450, 480) polls for available sensors and other contextual information providers. The polling results are then sent back to the system. The APA 476 synchronizes the availability of client/satellite device sensor and contextual information providers per client device. When required, it may also pick one sensor provider out of many providing the same stream (for example the system may choose to use the GPS sensor of a tablet device against the GPS sensor of a smart-watch attached to it).

The system then instructs all plugins responsible for interfacing with an endpoint client device (e.g. 450,480)/satellite services to start capturing. A real time message is sent to all client devices, containing the instructions to start capturing data/contextual information through their sensors. The client device APA client engine (e.g. 456, 486) propagates this message to the appropriate drivers. The drivers propagate (via a local device to satellite communication engine such as 458,488) this message to the respective associated satellite device(s) (such as 461,491). Each plugin initializes its recording mechanism, without starting the recording yet, and reports its state back to the system. The system, through APA 476, synchronizes all the recording states received from all the drivers of all the client devices and satellite devices in the session. Once all system services have reported that they are initialized, a message is sent by the system to all client devices in the session. The APA client engine (e.g. 456, 486) of the client devices synchronizes the recording state of each external service to its respective service plugin, which in turn modifies the client device UI appropriately. Based on information provided by the system, each plugin chooses the frequency and channel in which it delivers data to the system.

In a situation where two or more user end point devices carry satellite devices that are able to exchange information with each other when they are in close proximity, the system might choose to instruct the satellite devices to talk directly to each other and back to the system by means of direct links like the 493. The system might also choose to use a possibly better or faster communication channel which exists between the satellite device and the system 470 to carry contextual or other data (depending on size and frequency of sending) from the end point device to the system via the local satellite device (e.g. 461->462->470 or 491->492->470). This can be extended to form a contextually rich network of satellite devices that the system can reach and query regarding the participants' ambient status (might be asking for their permission). This greatly enhances the breadth and depth of meaningful contextual information during meetings and collaborative sessions happening at the same location, and shares the overhead of sending large amounts of data to the system through the process of sharing a small data load to be carried out from each device.

### Ending the Captured Session

At any point, participants can leave the session. The system 470 ends the session when all participants have left it, but as an option, the organizer might chose to send the command to end the session. There is a process for gracefully ending the sessions and collecting all recorded data. The process involves writing all collected data to the organized databases in 478 from where the system can retrieve them, analyze them and get meaningful decisions such as search and discovery and pattern based prediction by using Artificial Intelligence (AI), semantics (Sematic nets) and analytics in 479.

The following process allows the system to “tether” those inputs into one “central timeline” which allows users to extract extremely meaningful contextual information.

Upon the notification of the session's ending, the system instructs all external and system services to close all handles and communication channels and prepare for delivery of the recorded content.

External services are notified via the APA 476 and depending on the method they have for notifying their clients, they send back to the system a secure URL (via paths such as the one depicted at the direct line 410-471), and a token by which the system can download the content to the system recording archives at 478. After successfully downloading the content, the external services are notified by the system that they can now delete all session-related content they storing. The above process (also referred to as the downloader) is responsible for orchestrating all downloads, and passing the appropriate information to child processes (sometimes called engines) residing either at the same server or—in the case of a scalable cloud computing architecture—in multiple servers for further storage and processing. These engines/servers might include but are not limited to database servers, media compression servers, content delivery network servers, media transcription servers, media translation servers, context classification engines, semantic/taxonomic process server(s), machine learning engine(s), analytics server(s) etc.

After the downloader has completed all necessary steps, the session is officially available via the system 470 UI so that the participants can perform the following actions with the content and context of the session: view (playback); edit and curate; further contextualize with bookmarks, notes and other content; classify and categorize into their own library; package; request or give permissions to other users, groups and networks for sharing.

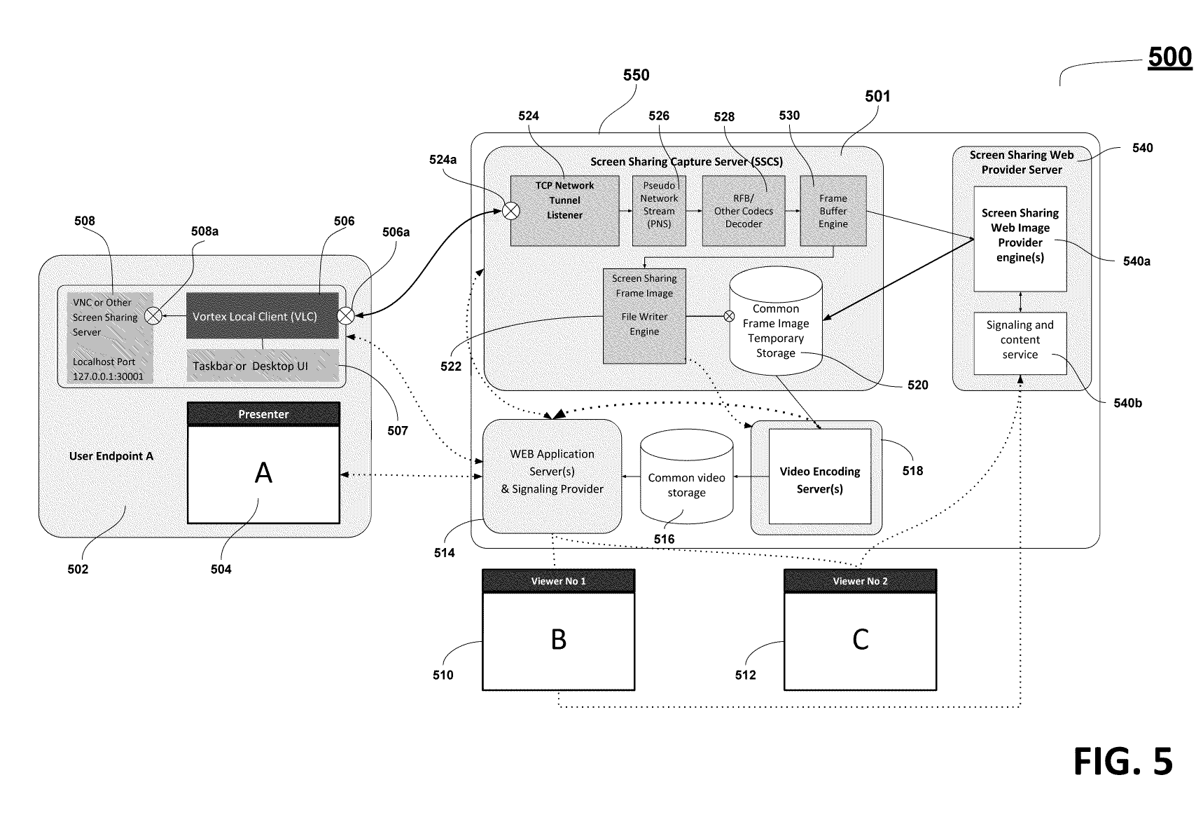

FIG. 5 is a block diagram of a system architecture illustrating a central infrastructure that facilitates the sharing of data (including screen sharing) from many sources, and recording of sharing sessions, according to an embodiment.

User endpoint 502, in an embodiment, is a device able to execute a Web Interface environment and a local application executable (a desktop computer, a laptop, a tablet, other web-enabled device, etc.). Points B 510 and C 512, in an embodiment, are devices able to execute at least a Web Interface environment. Central infrastructure 550 is a platform server infrastructure that includes the following elements in an embodiment: a server 514 that hosts and serves the web interfaces of User endpoint 502, Point B 510 and Point C 512 (such as IIS or Apache, etc.) as well as a web signaling application based on such a technology (such as SignalR. e.g.) that transmits signals to (theoretically) an unlimited number of points; a Screen Sharing Capture server 501 (further described herein); a Screen Sharing Web Provider Server 540 (further described herein); a group of one or more Video Encoding servers 518 that collect frame images and encode them to appropriate video files; a Common Video Storage 516 that stores all encoded video files and makes them available to Web server 514 to serve them on demand.

In general, the infrastructure 501 includes a server having components similar to the components shown in FIG. 5 and described below. For example, the server includes a processor, memory, applications, and storage. A web server 514 delivers web pages and other data from the storage to the browsers. Some examples of web servers include Apache, Internet Information Services (IIS), nginx, and others.

A presenter 504 at user endpoint A 502 wishes to initiate screen sharing so she can share her screen to one or more viewers like viewer 510 at Point 13, viewer 512 at Point C and so on. Point A signals server 514 of the central infrastructure 901, using a particular signaling protocol that the user wants to share their screen. The central infrastructure 501 now prepares itself for screen sharing and cloud recording by synchronizing all its components and issuing security tokens for all participants to exchange so they can securely view the screen sharing data. If needed, Point A 504 prepares a UI so that the Vortex local client 506 can be downloaded if it does not exist already in the device. The download can be done by means of many methods, depending on the platform of the device and the browser used (e.g., direct download, APP download for mobile devices, Java for Unix/Linux, .Net Clickonce for Windows, etc.). During this phase of the process, the appropriate UI code to instruct the user is loaded by the endpoint 504 interface.

The user at the user endpoint 502 as described above, downloads and runs the Vortex local client 506. When the local client 506 is run, desktop UI 507 asks for the permission of the user at 502 to run under her credentials (out of the browser sandbox). The respective plugin code runs within the context of the user endpoint 502, and also checks in this user's home directory to verify the Vortex local client application 506 exists and has been updated. If it exists and the version is current with the cloud version, then the endpoint 502 instructs the system to run the Vortex local client 506.

Now since the Vortex local client 506 is executed in the context of the local user device (does not need any more elevated permissions to run) it connects via the desired signaling protocol to Web Application and Signaling Server(s) 514 and notifies the Screen Sharing Capture Server 501 with security tokens so that all viewers (like the viewers at 510 and 512) can be securely connected. After this sequence, a UI screen sharing button in point A 504 becomes active so that the presenter at User endpoint 502 can point and click to start sharing his screen. When the screen sharing button is clicked, a new message is sent to the signaling server 514 to notify server 501 that it is now starting to share the screen. Server 501 prepares incoming TCP socket at 524a to accommodate a secure connection by the endpoint 502, by means of a persistent session allocation table (which can be implemented with various resilient technologies like a Redis or SQL based back plane) and it ensures scalability, location independence and effective session scheduling.

At the same time, at endpoint 502 the Vortex local client 506 prepares an outgoing secure connection to the TCP Socket 524a of the server 501 and starts a local process that will host a widely used screen sharing server (such as VNC) or any other server based on a similar screen sharing technology and is instructing it to listen at a localhost (127.0.0.1 in TCP terms) port 508a. In an embodiment, this port is in the range of 30000-65000 e.g. P=30001, but embodiments are not so limited. For machines that already provide a local screen sharing (therefore VNC compatible) server connectivity (e.g. Apple Macintosh) the local VNC 508 may be listening to another TCP port 508a (e.g. 5900). The Vortex local client 506 now binds points 508a, 506a and 524a effectively creating a tunnel from which it can pass all traffic from and to the server 501 including screen sharing data and special timing signaling explained below that creates a real time stream with exact timing information of the screen sharing process. It also spawns a native application 507 in the user endpoint A 502 context which runs and displays its UI on the desktop or taskbar of the endpoint 502. Through this UI application 507, communication with the local endpoint A 502 and its internals (depending on the permissions given by the user and the system) is possible. Such communication might be (but is not limited to) an interface to notify the user at endpoint 502 or interact with her in ways that the web Interface 504 does not provide, upload local files, co-sign digital documents, communicate with “satellite” devices connected to the Endpoint 502, collect certain contextual information from the endpoint and its Display itself (such as window titles and positions, running applications, sensors data, time zone, local and wide area network information, Wi-Fi SSID, machine load, etc.) in the form of searchable text and/or other objects etc. All this information that can be collected by the Taskbar or Desktop UI 507 can be transferred via the Vortex local client 506 to the 550 infrastructure, stored and/or transmitted to other viewers such as 510, 512 and later processed later (for example, by AI-Analytics-Semantics engine 479 of FIG. 4).

The connected viewers at point B 510 and point C 512 (and t an unlimited amount of viewers via a web UI interface such as the 510 and 512) now receive signaling from server 514 and prepare a UI element that displays all screen updates coming from the screen sharing web provider server 540, display user endpoint A presenter's 502 local screen as transmitted in real time.

Presenter A 504 at user endpoint A 502 begins presenting her screen to one or more viewers B 510 C 512 and so on. In an embodiment, screen sharing capture server (SSCS) 501 executes a screen sharing method at this point. In an embodiment, this is possible because the previously created channel (as described with reference to the forgoing Figures) is carrying all screen updates through this reliable TCP connection. This allows the infrastructure 501 to capture the updates sent by the local VNC server 508 via the Vortex local client 506 and the TCP Network Tunnel Listener 524 component to the Common Frame Image Temporary Storage 520.

The capabilities of the current system and methods enable this functionality. As an example comparison with conventional systems with similar missions, most remote frame buffer protocol servers (VNC for example) are completely lacking timing information because they are based on the assumption that the viewer component (after receiving the updates) will trigger the screen sharing server to send more updates. The exact time of each update is not captured or transmitted. Such previous systems are adequate for interactive sessions when a viewer can wait to view the screen even from a slow network. But they are not suitable for real-time recording where each frame must be marked with a specific timestamp.

The disclosed system and method includes specific timing information that is wrapped around the TCP packets originating from the screen sharing server 508. This information serves not only in carrying the correct timing but also in understanding network congestions and therefore allows the system to adapt the rate of uploaded screen frames so the line can handle the traffic. This involves a “headless” virtual viewer which resides in 528 and decodes all encoded screen traffic but also signals the 508 screen sharing server via the created tunnel mentioned above to send more updates when everything is decoded on this component (528).

Furthermore, it is thought that we could add immense value to the contextualization of the information coming from the presenter's 504 side by enabling all information collected via the Taskbar or Desktop UI 507 (as described above) to be carried, decoded and stored and/or transmitted and later processed by the infrastructure 550.

This method is used to decode the selected screen sharing protocol (like VNC) on the Server 501 and create a playback file with all captured screen and other contextual augmented data updates that are stored at the storage 520 and can then be transmitted, converted and stored at the 516 storage with the intent to be played at a later time by users of the service that have access and want to review the session.

In an embodiment, a method proceeds with the server 501 creating a series of processing points namely 526, 528, 530, 522 where all the processing and business logic takes place. The server 501 attaches to the internal TCP network stream that was flowing from the Screen Sharing local server 508 to the TCP Network Tunnel Listener 524 and spawns a new pseudo network stream 526 (an in-memory stream called “PNS”). At the same time, all screen frame update data is selectively written by another component 522 to an encoded RFB stream file at Storage 520 that can be decoded and replayed in any device later on (in a proprietary Screen Sharing Recording format which also contains timing and other meaningful contextual information from the User Endpoint A 502 as mentioned above).

Another novel approach is that we do not transmit raw screen sharing data to the viewers at B 510 and C 512 and any other viewer that may connect to the session. That would involve sending massive amount of data to (possibly thousands of) viewer connections of different capabilities therefore making the user experience unbearable. Instead, all the images are written to the Common Frame Image Temporary Storage and the Frame Buffer Engine 530 component informs the Screen Sharing Provider Server 540 that a new set of screen updates is available in the Storage 520. The Screen Sharing Web Image Provider engine 540a pulls the necessary images, and depending on the information it keeps for all connected viewers (like B 510 and C 512) about the latency and capability of their web connections, it compresses, encodes in a easily web decoded format the screen sharing web images and serves them in an adaptive and customized rate to each viewer, therefore saving bandwidth, energy and costs and creating an exceptional user experience to all active participants. The method also cares for the participation of any other clients that may join the real time screen sharing session at various times after the start of the session and until it ends.

After the screen sharing session ends by user intervention or for any other reason, the Screen Sharing Frame Image File Writer Engine 522 writes a special crafted description file and notifies the Video Encoding Server(s) 518 with all the necessary info. The Server 518 is then pulling all the Frame Image and Contextual Data collected from the session and decodes them to one or more files of various formats that can be played later by viewers. After all the encoding/transcoding operations are finished, the server 512 notifies the Web Application Server(s) 514 so that the session's status is updated in the infrastructure and the users of the system can view the recorded screen sharing session from various devices and connections.

In case of “Solo” Sessions, the same process is applied except that the viewers at points A 510 and 512 do not exist and the Server 540 does not participate in processing.

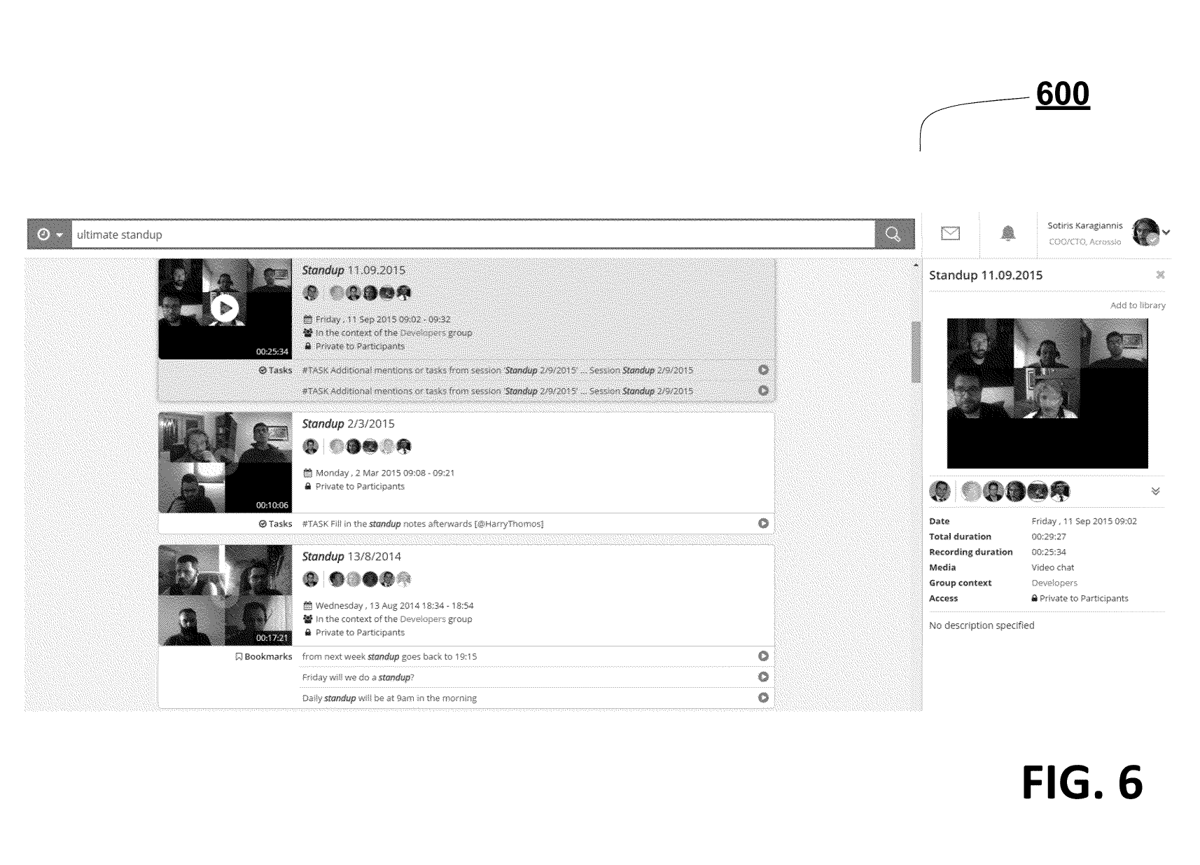

The users of a people network supported by the system can visually browse or search for past sessions according to the permissions granted them and if authorized they can view or even curate the above sessions. FIG. 6 is a diagram of a UI screen 600 showing information regarding a session that happened in the past, and is now being accessed. Using the UI of FIG. 6, the user visits a web address and can play back the whole session. In an embodiment, the UI includes the following elements, which are not intended to be limiting.

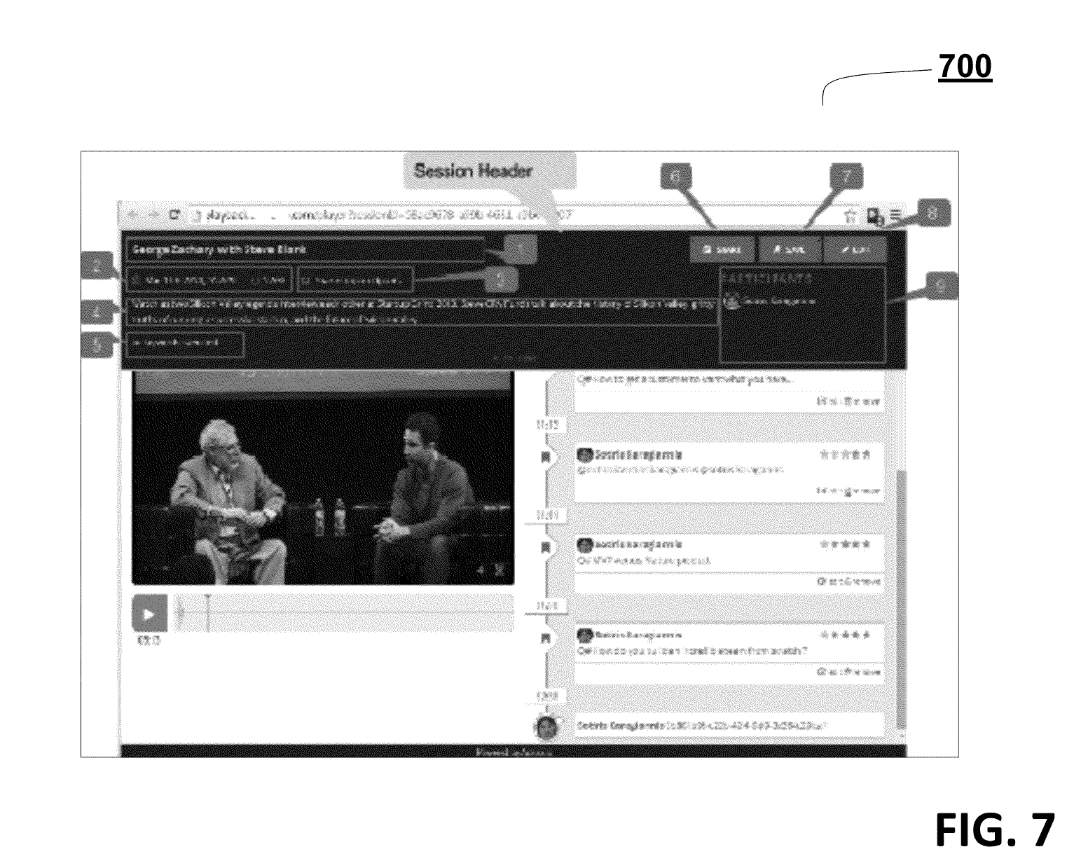

In an embodiment a session header region of the UI, shown in FIG. 7, is expandable and collapses back to save space, where the user can see important session information and if she is authorized to do so, she can interact and edit with the sessions vital information. The session header region can include the title of the session, date and the time the session occurred, the duration of the session, permissions of the session (private, shared, in the context of a group, etc.), a description or agenda of the session, session keywords as defined by the organizer.

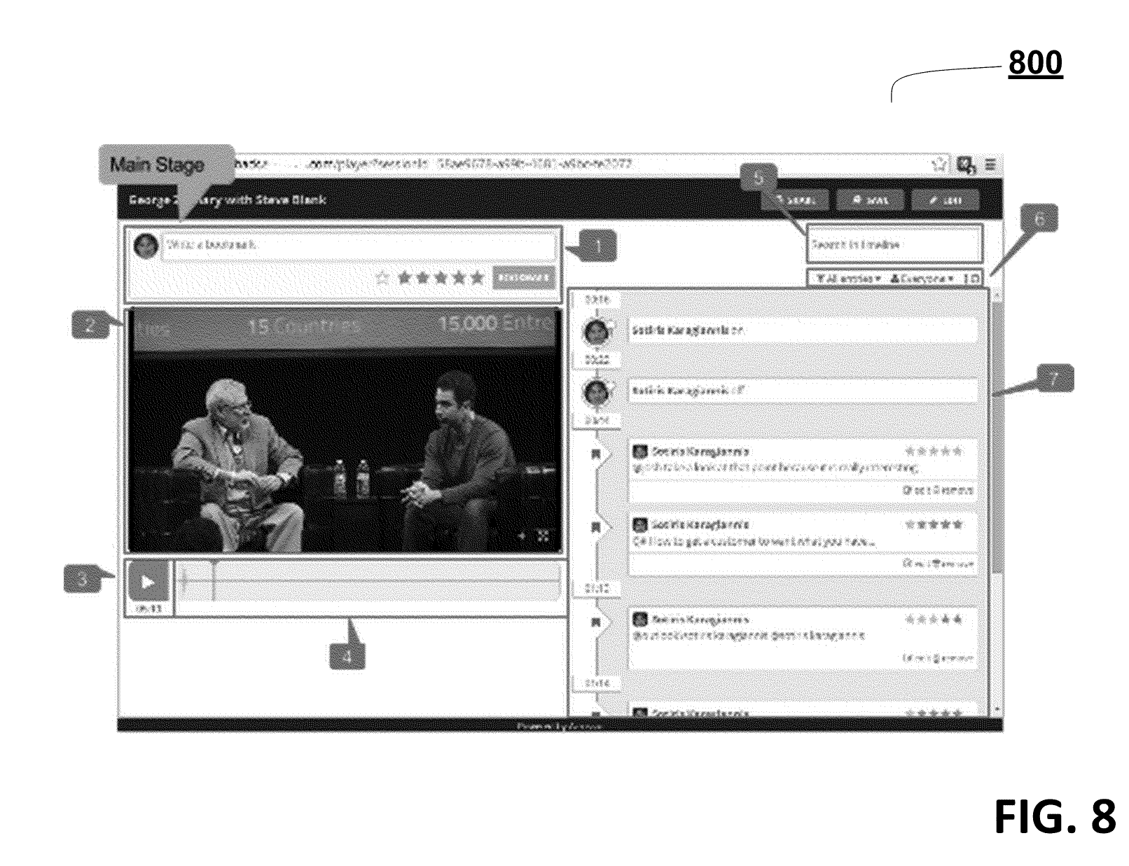

The user can share the session and give permissions to other users and groups or even networks. The user can save the session in a personal library. The user can also edit the session details and define the session thumbnail image. A main stage region of the UI is illustrated in FIG. 7 and FIG. 8. In the main stage region, all the action of the session can be observed. The main stage region consists of such an element, but the listing is not intended to be limiting.

In a bookmarking area (1), the user can bookmark any point of the session by pressing the cursor into the text area. At that point, she can chose not only a rating from the stars in the right (from 0—no rating and 1-5 rating) but also define the exact time the bookmark is effective from and the duration of the bookmarked time region. This way, the user can add exceptional relevant context to recorded sessions and even reference other people of the network or session participants. Depending on the duration and the rating of the bookmark, the contextual timeline shows in real time the width and height of the bookmarked region inside the total session timeline, helping the user understand how it influences the total context and relevancy information of the session. The user can also define the visibility of the specific bookmark (private, visible to participants etc.).

The mainstage region further includes a media and content region (2) where all recorded streams as well as all externally included media streams that have been added by users during the RTKS (Real Time Knowledge Sharing session) are being synchronized and played back.

Timeline controls (3) are UI elements that synchronize all streams of contextual information and media playing so that they appear as a consistent time related contextual combination. All contextual information is displayed in a contextual timeline region (4). Contextual information encompasses time instances, duration, relevancy, intensity of the session (in the form of heat maps), personalization with respect to the people's bookmarks or comments, etc. The timeline region (4) is a live region that changes depending on the user's needs to show the most meaningful information. Important bookmarks are shown with higher vertical/horizontal lines and long ones with a longer region. Also, results from a search area (5) are shown in the timeline allowing users to see the mentioned keywords in bookmarks, transcription texts, chats, file shared content, comments, etc. The context and content search area (5) allows the user to search for words, phrases, or concepts and the results are displayed in both the horizontal/vertical contextual timeline (4) and a contextual streams area (7).

A filters area (6) allows a user to choose from a plurality of filters including but not limited to: type of contextual entry (bookmark, chat, file, notes, slide sharing notes, transcription scripts, etc.); source of the entry (user, participants, other people, etc.); time information of the entry (creation and last modification time, versions, etc.); and permission type of the entry. The contextual streams (7) area can be viewed as an analog of the contextual timeline's vertical/horizontal detail. Similar to a social media stream, the contextual streams area (7) is contributing to the contextualization and virality utilization of the system. At the left of the area, there is an absolute time value denoting the time from the start of the session. There are several regions with the appropriate “boxes” for bookmarks, chat elements, and other contextual information like transcription scripts, action items (assigned tasks, external notification, etc.), comments, replies each containing the owner (the source of the information) and relevant signs and controls (such as rating or editing, sharing, replying, deleting, mentioning etc.) of the specific content and context. The area can take all forms of content as a reply and will adapt itself to the user interface of the user's client device. Contextual stream entries are issued a permalink upon entry. These permalinks refer to a specific part of a session which can be replayed automatically upon navigation to the permalink. Furthermore a follow-on (new) session may be launched from any session element such as bookmark or text chat entry, etc.

Editing and curation tools enable user to hide or clip parts of a session and/or enables the splicing of parts of a single or multiple sessions into a new session while maintaining associated contextual stream.

Editing and curation tools enable a collection of bookmarks/permalinks to be added together during curation to create a montage of results of relevant or sequential meetings. For example the curated montage can show the progression of the development of a solution. During the editing and curation phase, all users that are concurrently viewing or editing a session are known to the system and therefore if they chose to be visible to others, further collaboration and social interactions can occur under the editing and curation phase.

Users can also call other users and launch a new follow-on session in order to enhance or further elaborate on a specific part of the session which is played back (such as externally included content, a shared file, text chat entry, bookmark etc.). When the new follow-on session is finished a link is added to the contextual stream of the original session allowing visitors to quickly access the new follow-on session. Thus a tree-like session structure is generated, where users can easily navigate to all the enhancement or follow-on sessions of the specific session.

The editing and curation of sessions is made possible with the above interface and the system is notified in real time for all the changes as well as all contextually important statistics of the specific UI. These includes but are not limited to: page visits; people that visit the page; people viewing or editing the page at the same time; people adding new information; people that share specific bookmarks or other contextual elements with their colleagues; saves in people's personal library; and source pages that linked to this page.

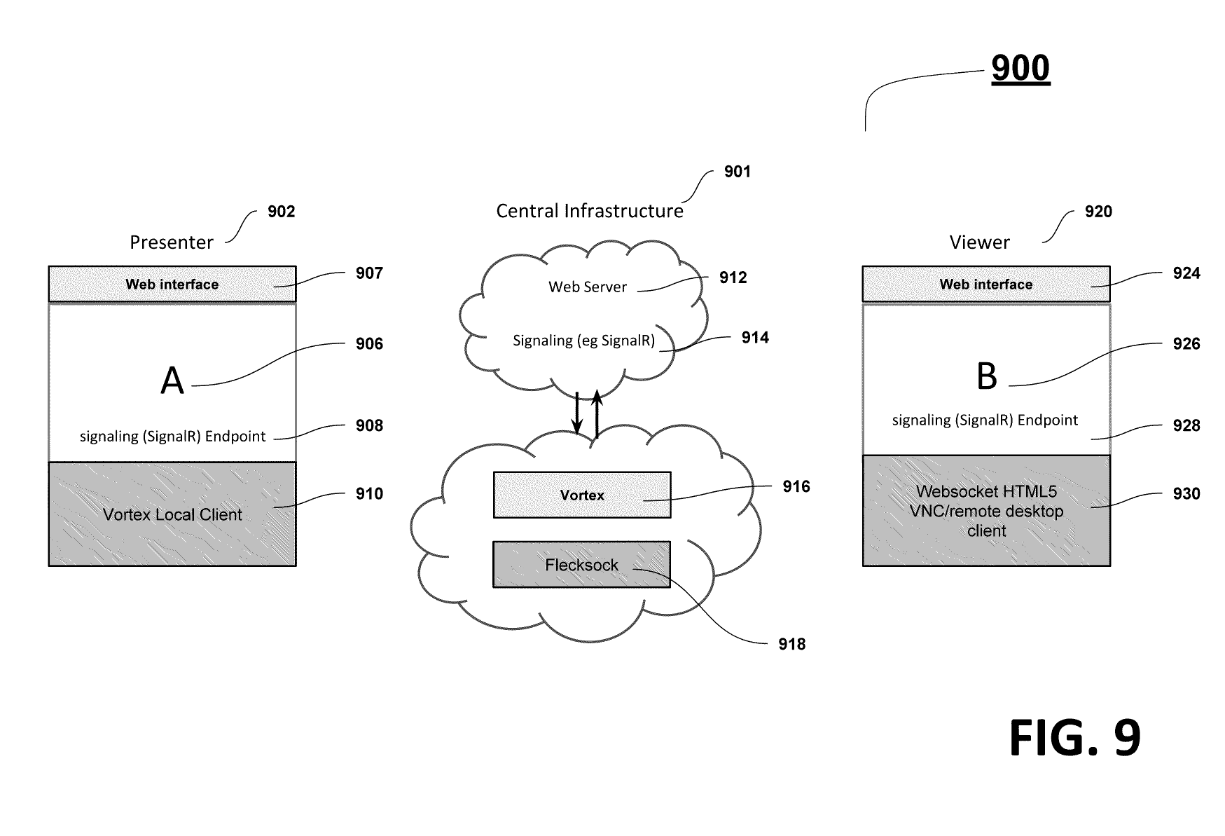

FIG. 9 is a diagram of a screen sharing apparatus and method, according to an embodiment. Point A 906 in an embodiment, is a device able to execute a Web Interface environment and a local application executable (a desktop computer, a laptop, a tablet, other web-enabled device, etc.). Point B 926, in an embodiment, is a device able to execute at least a Web Interface environment. Central infrastructure 901 is a platform server infrastructure that includes the following elements in an embodiment: a web server 912 that hosts the web interfaces of both Point A and Point B (such as IIS or Apache, etc.); a web signaling application 914 (such as SignalR, e.g.) that transmits signals to (theoretically) an unlimited number of points; vortex engine 916 (further described herein); and FleckSock 918, which is defined to be a WebSocket to TCPSocket conversion engine or an engine that can convert between different communication protocols.

In general, the infrastructure 901 includes a server having components similar to the components shown in FIG. 9 and described below. For example, the server includes a processor, memory, applications, and storage. A web server 912 delivers web pages and other data from the storage to the browsers. Some examples of web servers include Apache, Internet Information Services (IIS), nginx, and others.

A presenter 902 presenter at Point A wishes to initiate screen sharing so she can share her screen to a viewer 920 at Point B. A point A signaling endpoint 908 sends a notification to component 914 of the central infrastructure 901 that she wants to share her screen. The central infrastructure 901 now prepares itself for screen sharing and cloud recording. Point A 906 through the 908 endpoint signals the signallR 914 to provide a new security token (TOKEN-A) for screen sharing. The web server 912 receives the message from signallR 914, sends an acknowledgment message to Point A 906 via 914, prepares TOKEN-A, and when ready, signals Point A 906 to prepare a download UI.

Point A 906 prepares a UI so that Vortex local client 910 can be downloaded if it does not exist already in the device. The download can be done by means of many methods, depending on the platform of the device and the browser used (e.g., direct download, APP download for mobile devices, Java for Unix/Linux, .Net Clickonce for Windows, etc.). During this phase, the appropriate UI code to instruct the user is loaded by an endpoint 906 interface.

Presenter 902 as described above, downloads and runs the Vortex local client 910. When run, endpoint 906 UI asks for the permission of the local user (presenter 902) to run under her credentials (out of the browser sandbox). The respective plugin code runs within the context of the endpoint 906, also does some checks in the local user's (presenter 902) home directory to check if the Vortex local client application 910 exists and has been updated. If it exists and the version is current with the cloud version, then the endpoint 906 instructs the system to run the Vortex local client 910.

Now since the Vortex local client 910 is executed in the context of the local device user (does not need any more elevated permissions to run) it connects via TCP/IP to port SSL/443 of the Vortex server 916 and notifies Vortex server 916 with the Security TOKEN-A it received above. Vortex server 916 notifies SignalR 914 that the point A Vortex local client 910 is now connected and sends a message to Point A 906 that it can now turn on a UI screen sharing button to become active.

Point A 906 prepares the UI button so that the presenter 902 can click on it to start sharing his screen. Presenter 902 may now click on the above button in the UI interface of endpoint 906. When the “share screen” button is clicked upon, a new message is sent to the SignalR 914 hub and notifies Vortex server 916 again that it is ready to share the screen. Vortex server 916 then creates a new “V” session (VSESSION-A) that can accommodate the presenter 902, by means of a persistent session allocation table (which can be implemented with various technologies) and it ensures Scalability, location independence and effective session scheduling.

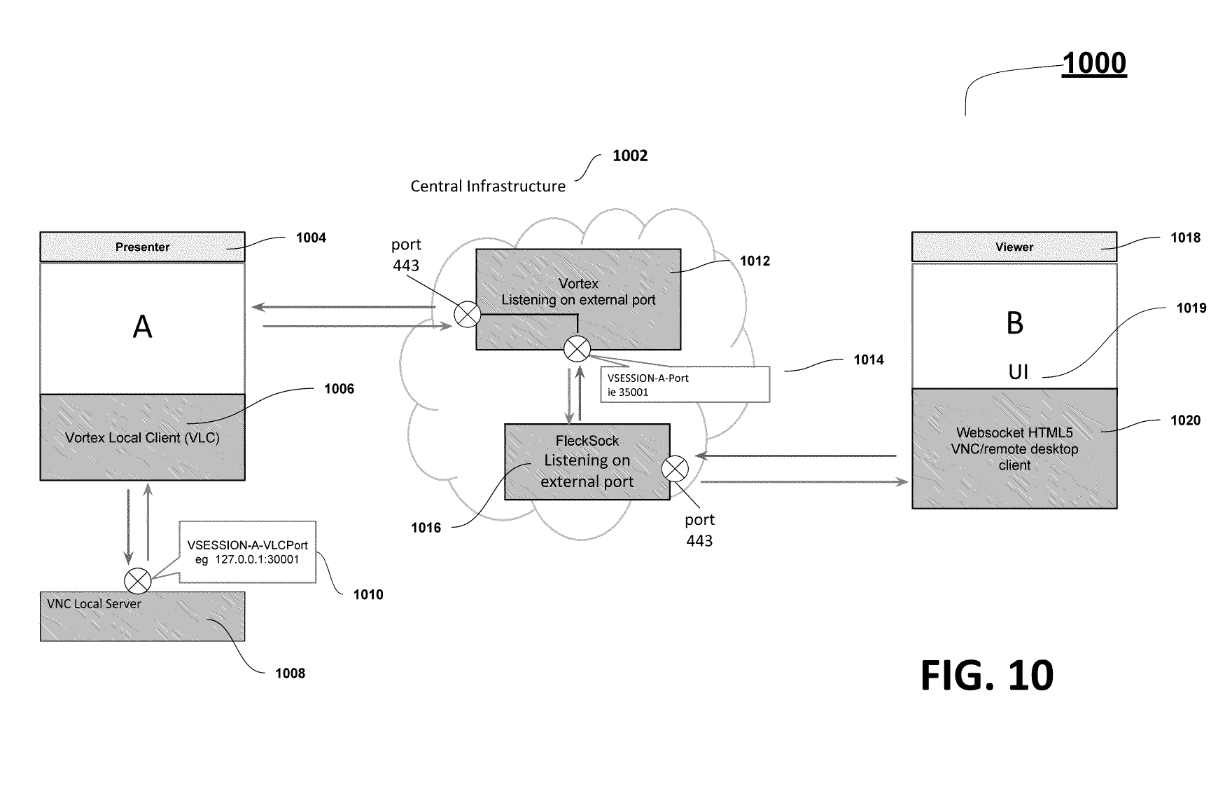

Now as it is depicted in FIG. 10, Vortex server 1012 opens a local (at the server it is running) TCP Listener called “ADAPTER LISTENER” at the first available port (VSESSION-A-Port), In an embodiment, this port is in the range of 35000-65000 e.g. P=35001, but embodiments are not so limited. The port is bound to the Vortex local client's 1006 VNC local server 1008 port VSESSION-A-VLCPort 1010 (e.g., VNC=127.0.0.1:35001). For machines that already provide a local VNC server connectivity (e.g. Apple Macintosh) the local 1008 VNC may be listening to another TCP port 1010 (e.g. 5900). Vortex server 1012 notifies SignalR 914 (not shown) back with a message containing the TCP Port (VSESSION-A-Port) it opened in the previous step (e.g. 35001) so that the Web VNC websocket client of the viewer 1018 at 1020 can connect.

Now, SignalR 914 transmits the above information to the viewer 1018 at a Point B UI 1019. Viewer B UI 1019 already knows the Viewer B 1018 ViewerB-ID (in an embodiment, this is in the form of an Acrossio User ID/GUID stored in the Database) and needs some more information to complete the connection. It needs the security token issued earlier in the process (namely TOKEN-A) and asks Vortex Server 1012 via the SignalR 914 path to provide it again with a security TOKEN-A it has issued earlier.

SignalR 914 gets security TOKEN-A to the UI 1019 of the Viewer at Point B which is now ready to connect with: ViewerB-ID@VSESSION-A combination string; security TOKEN-A; and VSESSION-A-Port Internal Port defined above (which is going to be available only for limited time span for security and scalability reasons).

Viewer B UI 1018 connects the HTML5 VNC Client 1020 via secure Websockets to the Flecksock 1016 listening at the external port SSL/443 of the Vortex Infrastructure Servers (FleckSock is the Web Socket Server component that translates data packets from WebSockets to TCP Sockets). Viewer B UI 1019 triggers the HTML5 VNC client 1020 negotiation for displaying Presenter A's 1004 local screen as transmitted by the Vortex Local Client 1006.

At this point Vortex server 1012 connects (bridges) the VSESSION-A-Port 1014 to the VSESSION-A-VLC Port 1010 and starts transferring data from the VNC local server at 1008 to HTML VNC Client at 1020.

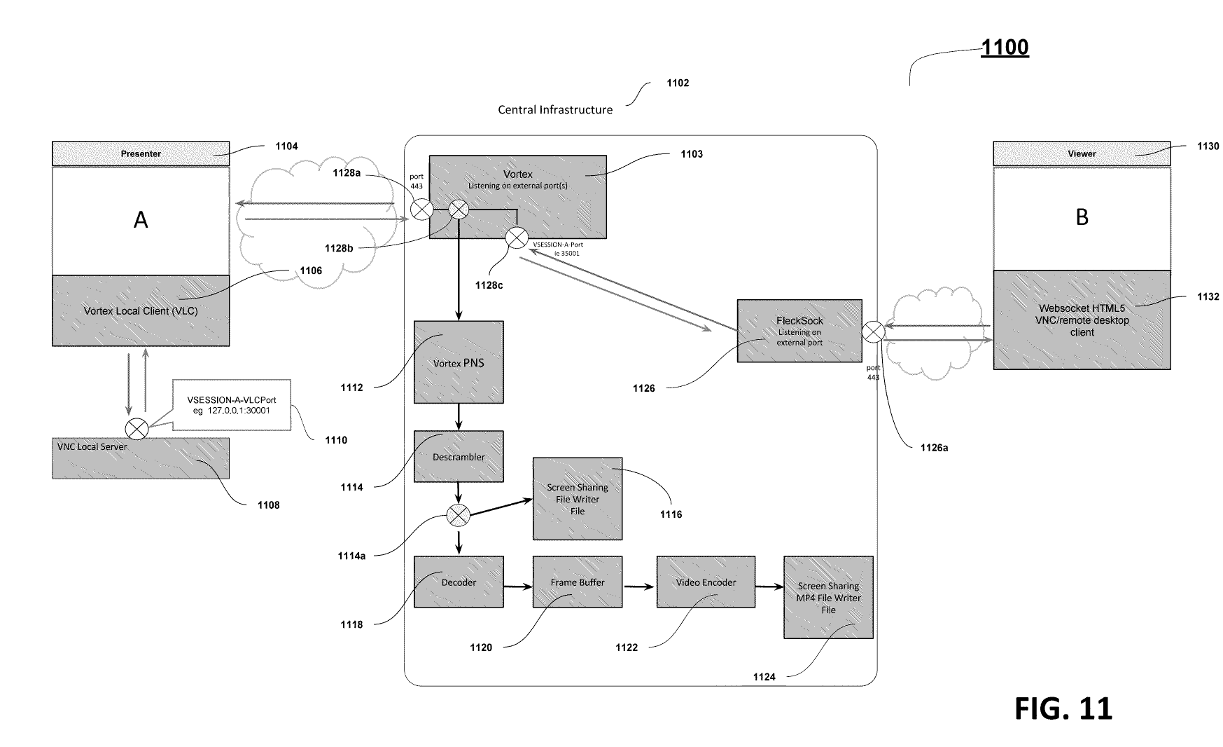

FIG. 11 is a diagram of a system 1100 illustrating a session recording process according to an embodiment. While presenter A 1104 starts presenting her screen to viewer B 1130, recording data may be captured via a T-junction 1128b which is securely created by the Vortex server 1103 in its internal memory structures. In an embodiment, this is possible because the previously created communication channel (as described with reference to the forgoing Figures) is carrying all screen updates through TCP and Web sockets. This allows the Vortex infrastructure 1102 to capture all updates sent by Presenter A 1104 since the Vortex local client 1106 is connected to the VNC local server 1108 via its TCP port VSession-A-VLCPort 1110 and carries traffic to the Vortex server 1103 via the path defined by ports 1128a, T-junction 1128b and VSESSION-A-Port 1128c and ultimately to the FleckSock server component 1126 and from there via port 1126a to the HTML5 VNC client 1132 and any other clients that may join the screen sharing session afterwards.

This method can be used to decode the VNC protocol (or similar remote frame buffer protocols) on the Vortex server 1103 and create a screen updates playback file that can be transmitted, converted or stored and played at a later time to users of the service that want to review the session. In an embodiment, a method proceeds with the Vortex server 1103 creating the T-Junction 1128b. The Vortex server 1103 attaches through 1128b to the internal raw network stream that was flowing from the VNC local server 1108 to the HTML5 VNC client 1132 and spawns a new pseudo network stream (a blocking in-mem stream called “Vortex PNS” 1112). The Vortex server then adds another component in the chain called “Descrambler” 1114 which descrambles the data packets encapsulating the encoded RFB Protocol (e.g. tightvnc). At the same time, all screen update data is written via another T-junction interface VSESSION-A-T-RFB 1114a to an encoded RFB stream file (Screen Sharing FileWriter File 1116) that can be decoded and replayed in any device later on (since we can simulate the Screen Sharing sequence format which might also contain timing).

To produce a standard video file (e.g. MP4 format) the process continues and a component named Decoder 1118 decodes the full stream and writes the screen updates to a memory frame buffer 1120. This frame buffer's output which now contains continuous image frames can be chosen to either be written on a file system storage using various formats (like MJPEG) or be encoded in real time (or offline) via a Video Encoder 1122 component to an MP4 universal format thus producing a universally playable video file, the Screen Sharing MP4 File Writer File 1124.

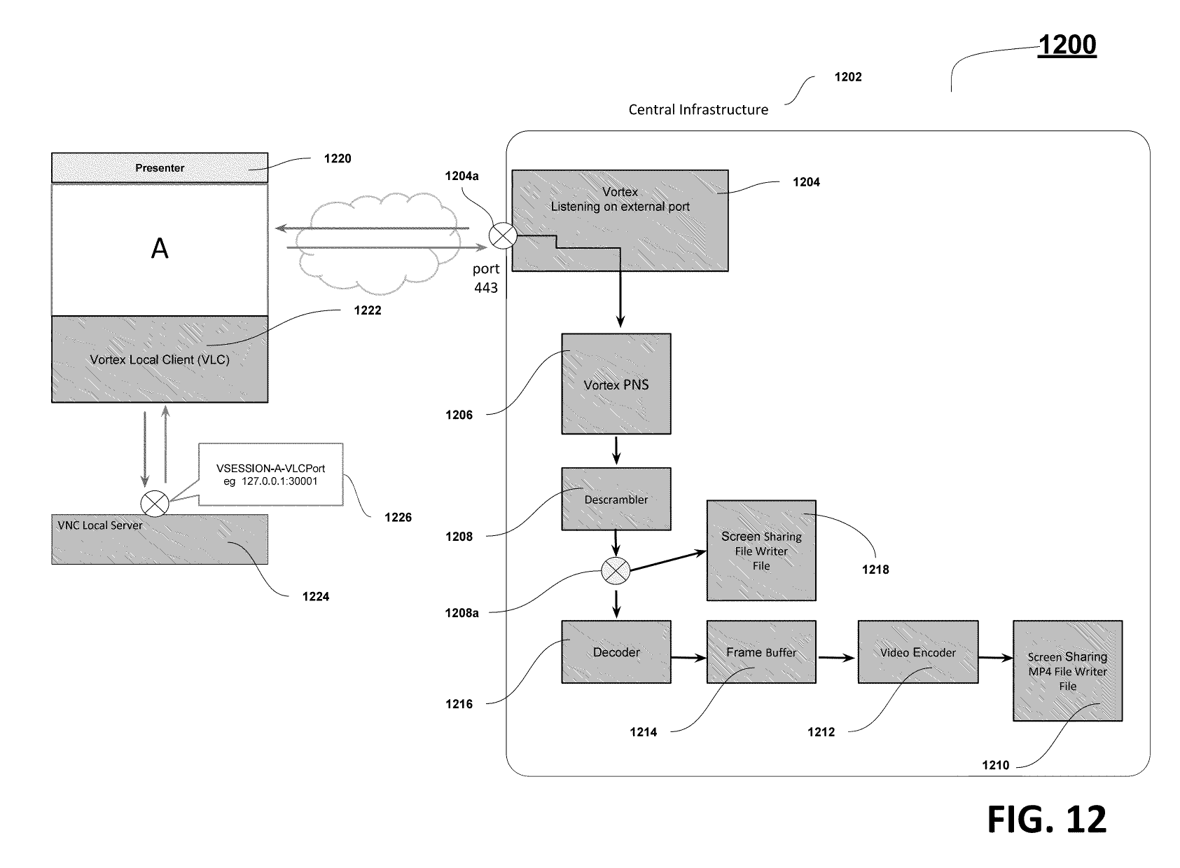

FIG. 12 is a diagram of a system 1200 executing a “Solo” session screen recording process according to an embodiment. Here, a web viewer does not actually exist. Instead, the PNS stream handles the whole screen sharing input stream and through a process similar to the one described with reference to FIG. 11. Both the native screen sharing file 1218 and the MP4 screen sharing file 1210 are recorded. In an embodiment, this is possible because the previously created communication channel (as described with reference to the forgoing Figures) is carrying all screen updates through TCP and Web sockets. This allows the Vortex infrastructure 1202 to capture all updates sent by Presenter A 1220 since the Vortex local client 1222 is connected to the VNC local server 1224 via its TCP port VSession-A-VLCPort 1226 and carries traffic to the Vortex server 1204 via external port 1204a.

This method can be used to decode the VNC protocol (or similar remote frame buffer protocols) on the Vortex server 1204 and create a screen updates playback file that can be transmitted, converted or stored and played at a later time to users of the service that want to review the session. In an embodiment, a method proceeds with the Vortex server 1204 directing the internal raw network stream that was flowing from the VNC local server 1224 to a new pseudo network stream (a blocking in-mem stream called “Vortex PNS” 1206). The Vortex server then adds another component in the chain called “Descrambler” 1208 which descrambles the data packets encapsulating the encoded RFB Protocol (e.g. tightvnc). At the same time, all screen update data is written via a T-junction interface 1208a to an encoded RFB stream file (Screen Sharing FileWriter File 1218) that can be decoded and replayed in any device later on (since we can simulate the Screen Sharing sequence format which might also contain timing).

To produce a standard video file (eg MP4 format) the process continues and a component named Decoder 1216 decodes the full stream and writes the screen updates to a memory frame buffer 1214. This frame buffer's output which now contains continuous image frames can be chosen to either be written on a file system storage using various formats (like MJPEG) or be encoded in real time (or offline) via a Video Encoder 1212 component to an MP4 universal format thus producing a universally playable video file, the Screen Sharing MP4 File Writer File 1210.

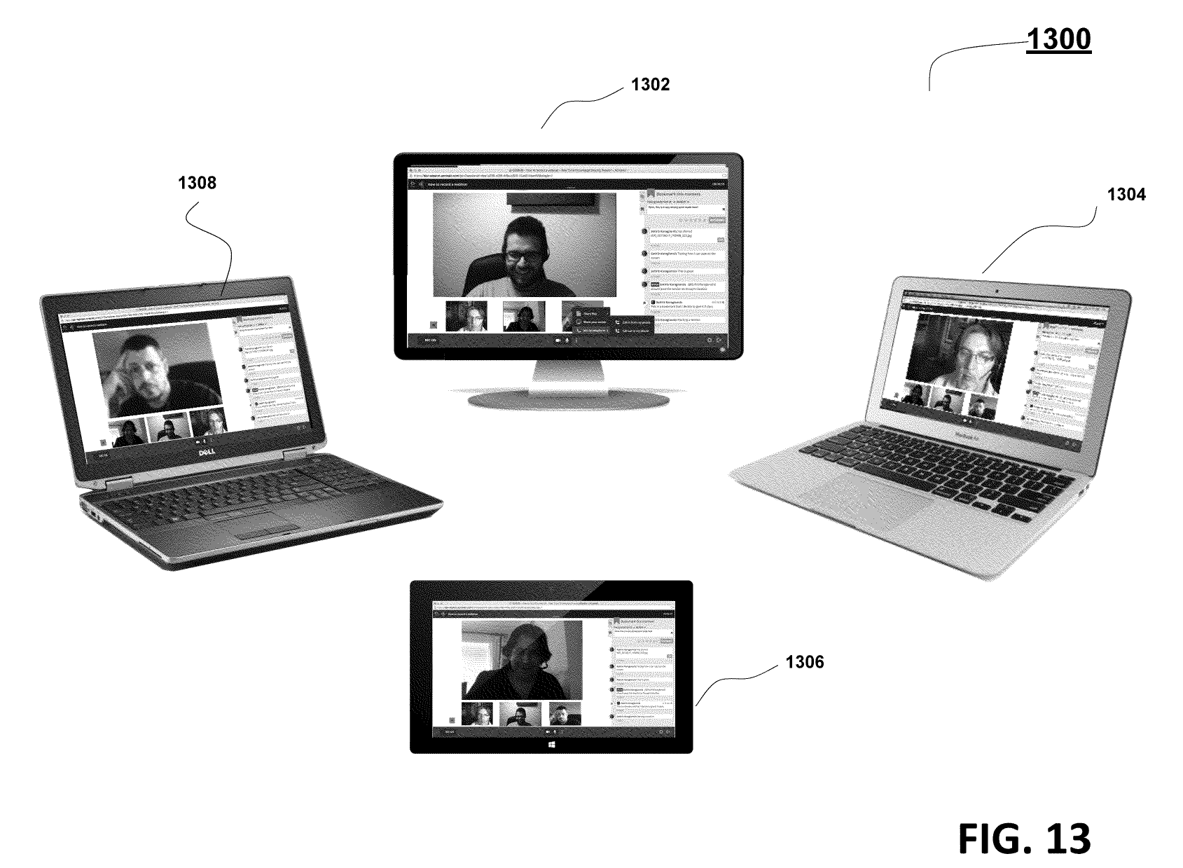

FIG. 13-FIG. 17 are diagrams illustrating use cases of the method and system. FIG. 13 shows a personal computer 1302, two laptop computers 1034 and 1038 and a tablet computer 1306, all of them are participating in a collaborative session. The PC 1302 displays live video from a session with all the contextual data on the right, while the laptops 1304, 108 and the tablet 1306 both display live video from the same session but each one from each user's point of view.

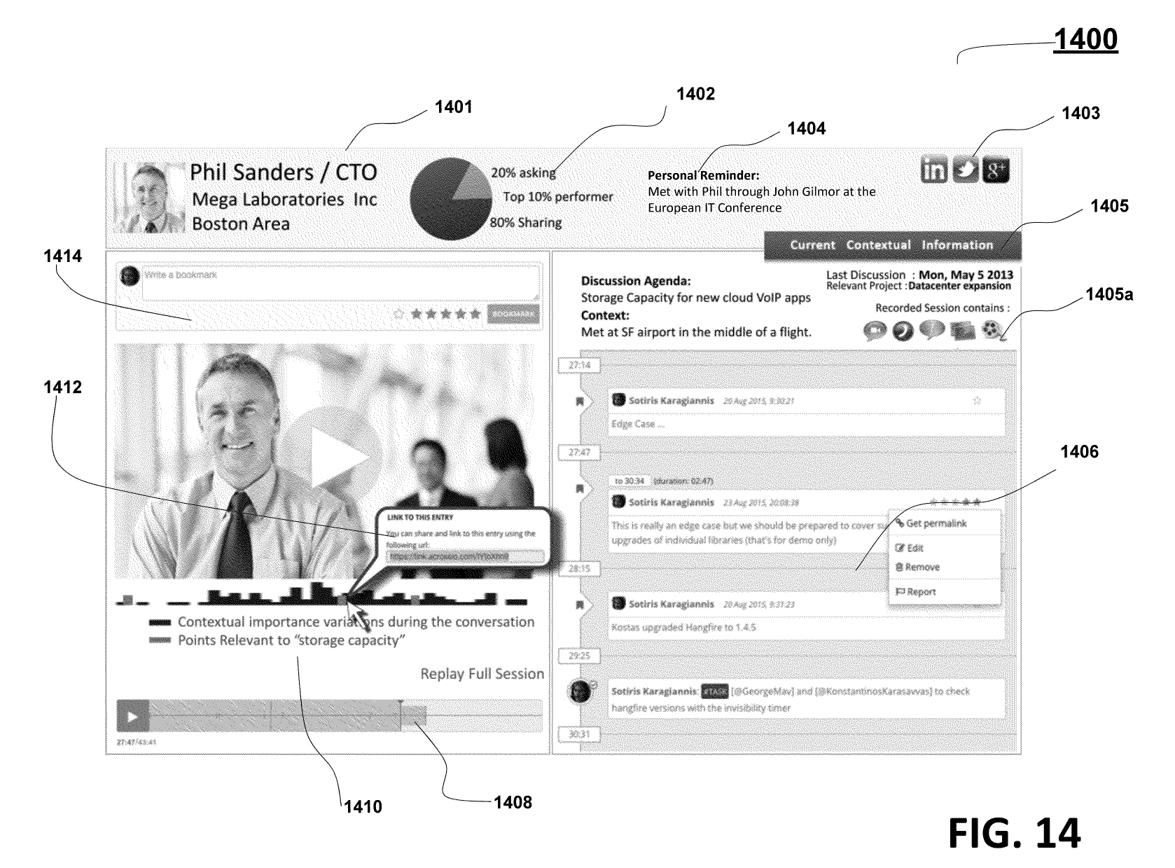

FIG. 14 is a diagram illustrating a UI screen 1400 that displays information regarding a user named Phil Sanders. On the top contextual information about Phil is shown 1401, including Phil's title and Company, geographical area. The social networks Phil participates in are shown in 1402. The percentage of information sharing Phil does vs asking questions is graphically shown 1403. Also shown is personal reminder 1404. In the Current Contextual Information area 1405 we see the date of last discussion, relevant project name, and discussion agenda. The graphic also displays icons representing the kinds of data the recorder session contains 1405a. These include (from left to right) video data, audio data, text chat data, screen sharing data and an external video file. Also the contextual timeline of the specific discussion is available at 1406.

On the left of the screen, a recorded session is shown as available for playback. The contextual importance variations during the conversation are displayed as a bar graph over the time of the conversation 1410. Also shown on the bar graph are specific points 1412 relevant to “storage capacity” which is a term from the name of the meeting agenda and can be shared by a “permalink” ie a web link/URL which is permanent through time. Additional context can be added via the 1414 interface for bookmarks and a navigation control for the session timeline is available in 1408.

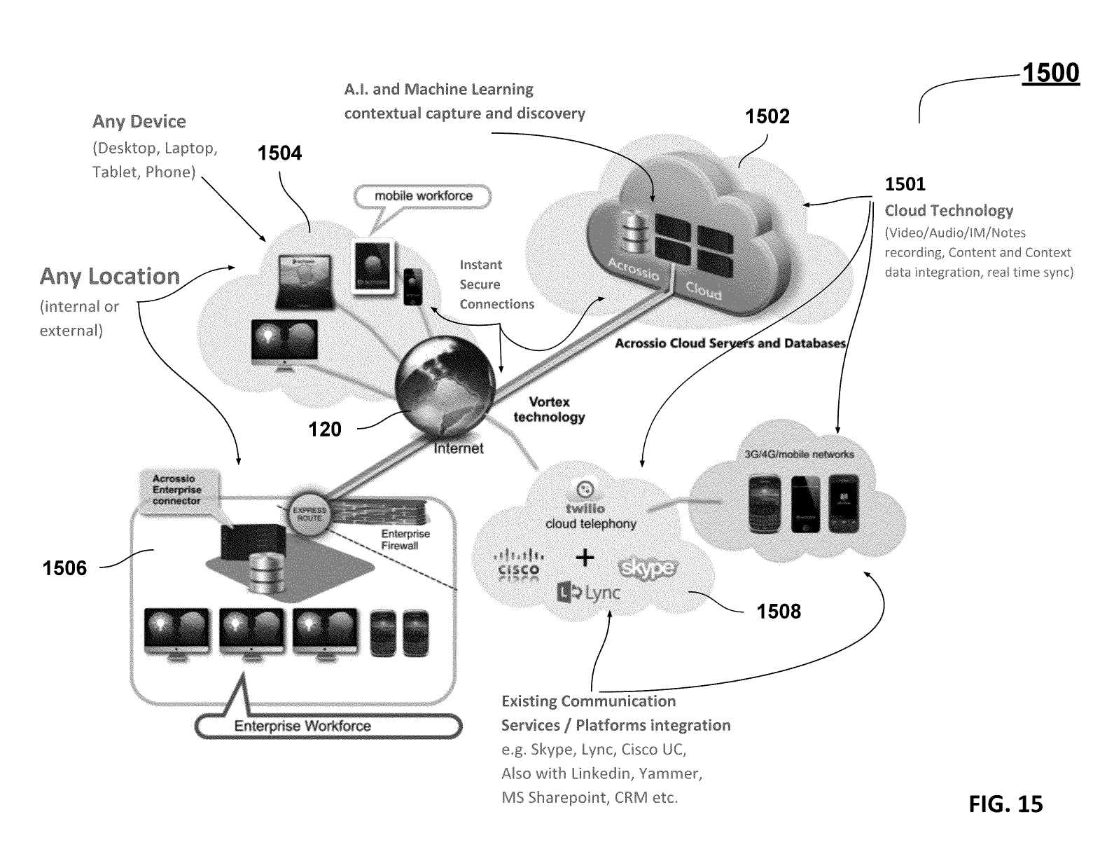

FIG. 15 is a diagram providing an overview of the system 1500 according to an embodiment. The system 1500 uses cloud technology 1501 to record various types of data, and to integrate content and context in real time. In an embodiment, cloud servers and databases 1502 such as but not limited to MS Azure™ which is Microsoft's Cloud Infrastructure communicate with both internal enterprise networks/systems 1506 and external, mobile workforce devices 1504 through Internet 120 via various types of cloud telephony 1508 to facilitate collaboration from anywhere using any device.

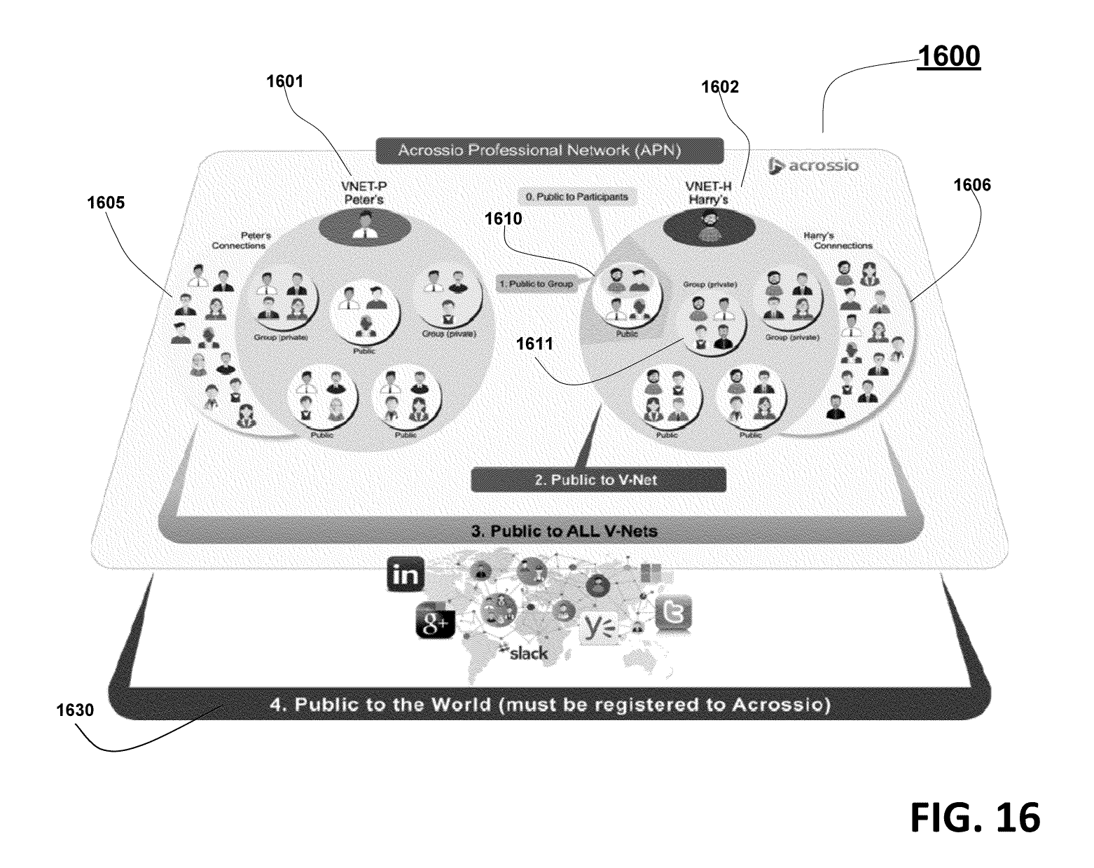

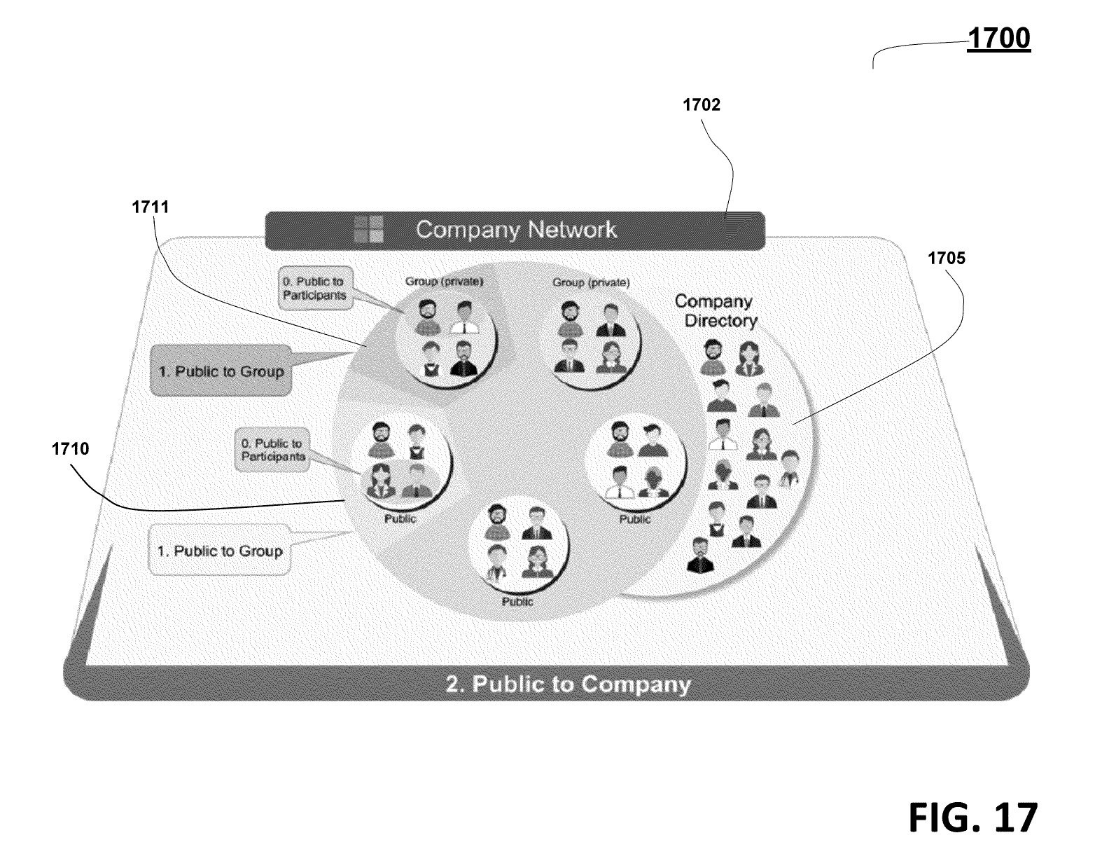

With reference to FIGS. 16 and 17, example diagrams show the collaboration network and sharing architecture.

FIG. 16 shows the structure of the Acrossio Professional Network (APN) 1600. This network structure is designed for use by independent professionals and their professional virtual networks VNETs 1601 & 1602. Each user invites individuals to join his network 1605 & 1606 on APN as his connections. He invites individuals using plugins to external services such as Linkedin, Google, Outlook 365, Yahoo, etc. Individuals that elect to accept the user's invitation, register on APN and become a member of user's VNET while starting their own VNET.

The user can invite members of his VNET 1606 connection list to join groups 1610 & 1611. The groups may be members of such things as Special Interests, Not for Profit events and other needs. Therefore users can collaborate with other users in context of a group activity or independent of a group.

Groups may be public 1610 or private 1611. Names of user members and content of a private group 1611 can't be seen by non-members while both content and names of user members are visible to other users in a public group 1610.

Content are contextualized saved media sessions. Content shared become public to those content is shared to or with.

Content is created by session participants as private to participants only by default. Any of the participants of the content can request for content to be shared with other users 1601 & 1602, groups 1610 or 1611, VNET 1601 &1602 or APN 1600 or shared and made public to the world using social media 1630. In all off these cases the content can become public only by unanimous participant consent.

Content created by members of a private group 1611 is created as private to participants only. Any participant of the content can request for content to be shared with members of private group 1611 or shared with the full group 1611. The content can become public to 1611 only by unanimous participant consent. Content from a private group cannot be shared with members outside of the group 1611.

Content created by members of a public group 1610 is created as private to participants only. Any participant of the content can request for content to be shared with members of public group 1610. The content can become public to 1610 only by unanimous participant consent. Any participant of the content can request for content to be shared with one or multiple members of their VNET 1601 or 1606 or shared with their personal VNET 1601 or 1602 or shared with the full APN 1600 or shared and made public to the world using social media 1630. In all off these cases the content can become public only by unanimous participant consent.

FIG. 17 is an embodiment with a diagram 1700 that shows the structure of a sample Company Network (CNET) 1702. This network structure is designed for the enterprise. Employee and contractor users of a company are invited by uploading an approved list of users into the CNET directory. Alternatively this list can be populated via plugins to external services such as Linkedin, Google, Outlook 365, Yahoo, etc. or internal services such as active directory or similar services.

Once users are registered in CNET they are part of the Company Directory 1705. These members of 1705 can be invited to join groups 1710 & 1711 within the CNET. The groups may be members of such things as Formal Department, Ad Hoc needs, Special Project, Function, Matrix Management and other needs. Therefore users can collaborate with other users in context of a group activity or independent of a group.

Groups may be public1710 or private1711. Names of user members and content of a private group 1711 can't be seen by non-members while both content and names of user members are visible to other users in a public group 1710.

Content are contextualized saved media sessions. Content shared become public to those content is shared to or with.

Content is created by session participants as private to participants only by default. Any of the participants of the content can request for content to be shared with other users 1701, and 1702, groups 1710 or 1711 or CNET 1702. Collaborative content developed in a CNET cannot be shared with anyone outside of 1705.

Content created by members of a private group 1711 is created as private to participants only. Any participant of the content can request for content to be shared with members of private group 1711 or shared with the full group 1711. The content can become public to 1711 only by unanimous participant consent. Content from a private group cannot be shared with members outside of the group 1711.

Content created by members of a public group 1710 is created as private to participants only. Any participant of the content can request for content to be shared with members of public group 1710. The content can become public to 1710 only by unanimous participant consent. Any participant of the content can request for content to be shared with one or multiple members of their CNET Directory 1705 or shared with the full CNET 1702. In all of these cases the content can become public only by unanimous participant consent. Collaborative content developed in the CNET 1702 cannot be shared with anyone outside of 1705.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A system for remote and local collaboration, the system comprising:
a central cloud computing infrastructure, including,
at least one server comprising processors, and data storage devices; and
a plugin architecture, executing a plurality of internal services for communicating with a plurality of external services, wherein the central cloud computing infrastructure stores instructions that when executed by the processors, cause the performance of a remote and local collaboration method, the method comprising,
synchronizing streams of data from a collaborative session, including contextual data:
capturing and archiving collaborative session data, including contextual data;
enabling indexing and search of the archived data, including search for a collaborative session, search for participants of the collaborative session, and search for keywords of a collaborative session.

2. The system of claim 1, wherein the central cloud computing architecture further comprises an artificial intelligence-analytics-semantics engine.

3. The system of claim 1, wherein the central cloud computing architecture is configured to communicate with a plurality of user devices to capture and archive collaborative session data.

4. The system of claim 1, wherein the system further comprises:
a network and synchronization component that communicates with the plugin architecture and with the data storage devices, wherein the network and synch component further manages the data storage devices and playback devices and their UI including,
storing system data, contextual data, and captured archived data; and
facilitating indexing and search of the archived data, including communicating with the artificial intelligence-analytics-semantics engine.

5. The system of claim 1, wherein the central cloud computing infrastructure further comprises:
a TCP tunnel listener;
a pseudo network stream (PNS) component;
a decoder component;
a frame buffer engine;
a file writer component and
an encoder component.

6. The system of claim 1, wherein the central cloud computing infrastructure further comprises:
a plurality of web application servers; and
video encoding servers.

7. The system of claim 1, wherein the central cloud computing infrastructure further comprises a screen sharing web provider server, comprising:
a screen sharing web image provider engine; and
a signaling and content service component.

8. The system of claim 1, wherein external services comprise any service with which the cloud computing infrastructure communicates via one or more application programming interfaces, the external services comprising:
networks, comprising Twilio™, Skype™, Vidyo™, Google Hangouts™, MS Skype for Business™;
cloud screen sharing services, comprising Screenleap™ and WebRTC™;
third party services, comprising email, note-sharing, file-sharing, co-browsing, real-time chat, Google Gmail™, Dropbox™, Google Drive™, Evernote™ Slack™ cloud messaging, YouTube™, Vimeo™, Twitter™, and Facebook™.

9. A computer-implemented method for remote collaboration, the method comprising:
a central cloud computing infrastructure comprising processors and data storage devices capturing data related to a collaboration session, wherein a collaboration session comprises multiple users accessing a remote collaboration system via one of a plurality of user devices that communicate with the central cloud computing infrastructure, wherein capturing data related to the collaborative session comprises,
data capture via external service, wherein external service are external to the central cloud computing infrastructure; and
data capture via internal services, wherein internal service are internal to the central cloud computing infrastructure.

10. The method of claim 9, further comprising:
the central cloud computing infrastructure receiving a message from an external service to start capturing the data related to the collaborative session;
the central cloud computing infrastructure instructing a plurality of plugins responsible for interfacing with external services to begin capturing; and
once the instructions are executed, a plugin architecture of the central cloud computing infrastructure logging a capturing state of the external service, wherein the capturing state is usable as contextual information regarding the collaborative session.

11. The method of claim 10, further comprising the central cloud computing infrastructure using a real-time communication channel to propagate a plugin recording state to the plurality of user devices.

12. The method of claim 11, wherein the central cloud computing infrastructure via the real-time communication channel uses the plugin architecture engines of the user devices to synchronize a recording state of an external service to a respective external service driver.

13. The method of claim 12, further comprising the user device displaying an appropriately modified user interface (UI) in response to the synchronizing.

14. The method of claim 9, wherein internal services are responsible for data capture, the method comprising:
the central cloud computing infrastructure receiving a message to start capturing data;
the central cloud computing infrastructure instructing all user device plugins responsible for interfacing with the central cloud computing infrastructure to begin capturing data;
the central cloud computing infrastructure receiving return messages from each of the user devices reporting respective device states; and
the central cloud computing infrastructure synchronizing the respective device states, wherein the respective device states comprise a recording state.

15. A non-transient computer-readable medium, having stored thereon instructions that when executed by a processor cause a remote collaborative method to be performed, the method comprising:
a central cloud computing infrastructure comprising processors and data storage devices capturing data related to a collaboration session, wherein a collaboration session comprises multiple users accessing a remote collaboration system via one of a plurality of user devices that communicate with the central cloud computing infrastructure, wherein capturing data related to the collaborative session comprises,
data capture via external service, wherein external service are external to the central cloud computing infrastructure; and
data capture via internal services, wherein internal service are internal to the central cloud computing infrastructure.

16. The medium of claim 15, wherein the method further comprises:
the central cloud computing infrastructure receiving a message from an external service to start capturing the data related to the collaborative session;
the central cloud computing infrastructure instructing a plurality of plugins responsible for interfacing with external services to begin capturing; and
once the instructions are executed, a plugin architecture of the central cloud computing infrastructure logging a capturing state of the external service, wherein the capturing state is usable as contextual information regarding the collaborative session.

17. The medium of claim 16, wherein the method further comprises the central cloud computing infrastructure using a real-time communication channel to propagate a plugin recording state to the plurality of user devices.

18. The medium of claim 17, wherein the method further comprises the central cloud computing infrastructure via the real-time communication channel using the plugin architecture engines of the user devices to synchronize a recording state of an external service to a respective external service driver.

19. The medium of claim 18, wherein the method further comprises the user device displaying an appropriately modified user interface (UI) in response to the synchronizing.

20. The medium of claim 14, wherein internal services are responsible for data capture, including:
the central cloud computing infrastructure receiving a message to start capturing data;
the central cloud computing infrastructure instructing all user device plugins responsible for interfacing with the central cloud computing infrastructure to begin capturing data;
the central cloud computing infrastructure receiving return messages from each of the user devices reporting respective device states; and
the central cloud computing infrastructure synchronizing the respective device states, wherein the respective device states comprise a recording state.

21. The medium of claim 17, wherein the method further comprises the central cloud computing architecture executing and updating the user interface (UI) that is displayed on the user device.
